(19) United States
(12) Patent Application Publication
(10) Pub. No.: US 2012/0201945 A1
(43) Pub. Date: Aug. 9, 2012

(54) FOOD COMPOSITION WITH REINFORCED OR ENHANCED SALTY TASTE AND COMPOSITION CONTAINING POTASSIUM CHLORIDE WITH SUPPRESSED OFFENSIVE TASTE

(75) Inventors: Shinichi Iwahata, Osaka (JP); Fumiaki Kurobe, Osaka (JP)

(73) Assignee: House Foods Corporation, Osaka (JP)

(21) Appl. No.: 13/499,731

(22) PCT Filed: Sep. 30, 2010
(86) PCT No.: PCT/JP10/67032

§ 371 Date: Apr. 2, 2012

(30) Foreign Application Priority Data
Oct. 2, 2009 (JP) 2009-230707

(51) Int. Cl. A23L 1/237; A23L 1/238; A23L 1/36; A23L 1/40; A23L 1/16

(52) U.S. Cl. 426/557; 426/649; 426/589; 426/629

(57) ABSTRACT

This invention provides a means for reinforcing or enhancing the salty taste of sodium chloride in a food composition and a means for suppressing the offensive taste in a composition containing potassium chloride. This invention relates to a food composition with a reinforced or enhanced salty taste realized with the addition of potassium chloride and acetic acid and/or lactic acid into a food composition containing sodium chloride. This invention also relates to a composition supplemented with potassium chloride capable of suppressing an offensive taste originating from potassium to which at least one selected from glutamic acid and aspartic acid has been added.

### TECHNICAL FIELD

The present invention provides a food composition with reduced sodium chloride content containing potassium chloride with a reinforced salty taste and a food composition containing potassium chloride with an enhanced salty taste without increasing the amount of sodium chloride.

The present invention also provides a composition containing potassium chloride with a suppressed offensive taste. The composition of the present invention is useful in the form of a food composition with reduced saline content.

### BACKGROUND ART

Adverse effects, such as high blood pressure, arising from excessive intake of sodium ions originating from common salt (i.e., sodium chloride (NaCl)) have been an issue of concern, and development of low-common salt foods with reduced common salt content has been attempted. Since low-common salt foods resulting from mere reduction of common salt content are not satisfactory in terms of salty taste, low-common salt foods supplemented with potassium chloride (KCl) have been developed as alternatives to sodium chloride in order to impart a salty taste without increasing the sodium content.

Potassium chloride has a distinctive metallic taste and bitterness (hereafter, it may be referred to as “offensive taste”) originating from potassium ions. Accordingly, techniques for suppressing the offensive taste of potassium chloride have heretofore been developed.

Claim 1 of Patent Document 1 describes a liquid seasoning agent comprising 9% or less common salt, 0.5% to 4.2% potassium, more than 2% acidic amino acid, 1% to 3% asparatic acid, and 1% to 2% glutamic acid by mass. Claim 1 of Patent Document 2 describes a liquid seasoning agent comprising 3.55% or less sodium, 0.5% to 4.2% potassium, more than 2% acidic amino acid, and/or more than 1% basic amino acid and 0.05% to 10% food material having blood-pressure-lowering effects by mass. Claim 1 of Patent Document 3 describes a liquid seasoning agent comprising 5.5% or less sodium, 0.5% to 6% potassium, more than 2% acidic amino acid, and/or more than 1% basic amino acid and 1% to 10% ethanol by mass.

According to the examples of Patent Documents 1 to 3, sodium salts are added as glutamic acid and aspartic acid, and glutamic acid or aspartic acid that is not in the form of salt is not added. According to Patent Documents 1 to 3, the amount of sodium glutamate or sodium aspartate relative to potassium is large, such amino acid salts exhibit distinctive flavors, and the salty taste thereof would not be equivalent to that of common salt. If the amount of acidic amino acid defined in Patent Documents 1 to 3 is added in the form of a free glutamic acid or aspartic acid instead of the form of sodium salt, strong acidity is imparted as described in the examples below, and a salty taste equivalent to that of common salt would not be attained. Since the purpose of preparing a low-common salt food is sodium ion reduction, in addition, it is not preferable that an acidic amino acid be used in the form of sodium salt.

Patent Document 4 describes the use of γ-polyglutamic acid in order to suppress the bitterness of potassium chloride or the like. Patent Document 5 describes a technique of using γ-polyglutamic acid to enhance the salty taste of common salt. However, γ-polyglutamic acid described in Patent Document 4 or 5 is a polysaccharide derived from Bacillus subtilis var. natto. Accordingly, it has a distinctive odor, and its effects of suppressing the offensive taste of potassium chloride or the like are insufficient.

Patent Document 6 describes a seasoning composition containing no or a small amount of sodium, which comprises: an acidulant selected from a group consisting of citric acid, tartaric acid, fumaric acid, lactic acid, and a mixture of any thereof, potassium salt, calcium salt, magnesium salt, and rice powder. Since this seasoning composition comprises various ingredients as essential components, it is considered to exhibit a flavor different from that of a common salt.

### PRIOR ART DOCUMENTS

### Patent Documents

Patent Document 1: JP Patent No. 4060843

Patent Document 2: JP Patent Publication (Kokai) No. 2007-89557 A

Patent Document 3: JP Patent Publication (Kokai) No. 2007-289083 A

Patent Document 4: International Publication WO 00/21390

Patent Document 5: International Publication WO 2007/108558

Patent Document 6: JP Patent Publication (Kohyo) No. 2010-521974 A

### SUMMARY OF THE INVENTION

### Object to Be Attained by the Invention

First Aspect of the Present Invention

There has been no previous technique for reinforcing a natural salty taste of a food composition with reduced sodium chloride content and for enhancing a salty taste of a food composition without increasing the amount of sodium chloride in it.

Specifically, potassium chloride is not capable of reinforcing the first taste, which is a taste felt initially, of a salty taste exhibited by sodium chloride, although it is capable of reinforcing the second taste, which is a taste felt after the first taste, thereof. With the use of potassium chloride alone, accordingly, it is impossible to reinforce a natural salty taste in a food composition with reduced sodium chloride content.

Accordingly, it is a first object of the present invention to provide a food composition with reduced sodium chloride content and a reinforced salty taste or a food composition with an enhanced salty taste without increasing the amount of sodium chloride.

Second Aspect of the Present Invention

No sufficient techniques for suppressing the offensive taste of potassium chloride added to foods have been provided in the past.

It is a second object of the present invention to provide a composition that is ingestible as a food exhibiting a salty taste similar to that of sodium chloride (common salt) and exhibiting suppression of the offensive taste of potassium chloride without yielding an unnatural flavor.

### Means for Attaining the Object

First Aspect of the Present Invention

The present inventors found that the salty taste exhibited by sodium chloride in a food composition would be reinforced or enhanced with the addition of potassium chloride and at least one acid selected from acetic acid and lactic acid, thereby completing the inventions described below.

(1) A method for reinforcing a salty taste of a food composition with reduced sodium chloride content comprising a step of adding potassium chloride and at least one acid selected from acetic acid and lactic acid, provided that a method of reinforcing a salty taste of a seasoning composition with reduced sodium chloride content comprising a step of adding potassium chloride, lactic acid, calcium salt, magnesium salt, and rice powder is excluded. Preferably, the method of (1) excludes a method of reinforcing the salty taste of another food composition by adding the seasoning composition with a reinforced salty taste to another food composition.

Examples of the calcium salts include edible calcium salts, such as calcium phosphate and calcium silicate. Examples of magnesium salts include edible magnesium salts, such as magnesium sulfate and magnesium chloride.

(2) The method of (1), which comprises a step of adjusting the amount of potassium chloride and the amount of the acid added to the food composition in accordance with the amount of sodium chloride reduced.

(3) The method of (1) or (2), which further comprises a step of adding at least one spice selected from among white pepper, black pepper, green pepper, ginger, zanthoxylum, capsicum, cumin, thyme, oregano, coriander, laurel, cardamom, mustard, cinnamon, garlic, rosemary, sage, basil, citrus unshiu peel, perilla, and lemon and/or an extract of any thereof.

(4) A food composition with reduced sodium chloride content to which potassium chloride and at least one acid selected from acetic acid and lactic acid have been added, provided that a seasoning composition with reduced sodium chloride content comprising potassium chloride, lactic acid, calcium salt, magnesium salt, and rice powder is excluded. Preferably, examples of the food composition of (4) exclude a food composition obtained by adding the seasoning composition to another food composition.

(5) The food composition of (4), which is any of sauce, soup, baste, soy sauce, bean paste, dressing, edible salt, seasoning, a snack, noodles, or seasoned rice.

(6) The food composition of (4), which is curry sauce, wherein the amount of sodium in terms of an amount converted to equimolar sodium chloride (i.e., the sodium chloride equivalent) is 1.25% by weight or less, and wherein the total amount of the acids is 2.6 to 52.0 parts by weight based on 100 parts by weight of the sodium chloride equivalent.

(7) The food composition of (4), which is curry roux used for preparing curry sauce, wherein the sodium chloride equivalent in the curry sauce is 1.25% by weight or less, and wherein the amount of the acids in the curry roux is adjusted so as to bring the total amount of the acids in the curry sauce to 2.6 to 52.0 parts by weight based on 100 parts by weight of the sodium chloride equivalent.

(8) The food composition of (4), which is curry roux used for preparing curry sauce, wherein the sodium chloride equivalent in the curry roux is 11.5% by weight or less, and wherein the total amount of the acids in the curry roux is 0.8 to 17.0 parts by weight based on 100 parts by weight of the sodium chloride equivalent.

(9) The food composition of (4), which is stew sauce, wherein the sodium chloride equivalent is 1.0% by weight or less and the total amount of the acids is 5.3 to 30.0 parts by weight, based on 100 parts by weight of the sodium chloride equivalent.

(10) The food composition of (4), which is stew roux used for preparing stew sauce, wherein the sodium chloride equivalent in the stew sauce is 1.0% by weight or less of the stew sauce, and wherein the amount of the acids in the stew roux is adjusted so as to bring the total amount of the acids in the stew sauce to 5.3 to 30.0 parts by weight based on 100 parts by weight of the sodium chloride equivalent.

(11) The food composition of (4), which is stew roux used for preparing stew sauce, wherein the sodium chloride equivalent in the stew roux is 8.5% by weight or less, and wherein the total amount of the acids in the stew roux is 0.7 to 17.0 parts by weight based on 100 parts by weight of the sodium chloride equivalent.

(12) The food composition of (4), which is soup, in which the sodium chloride equivalent is 1.3% by weight or less and the total amount of the acids is 2.0 to 16.0 parts by weight based on 100 parts by weight of the sodium chloride equivalent.

(13) The food composition of (4), which is a soup base used for preparing soup, wherein the sodium chloride equivalent in the soup is 1.3% by weight or less, and wherein the amount of the acids in the soup base is adjusted so as to bring the total amount of the acids in the soup to 2.0 to 16.0 parts of by weight based on 100 parts by weight of the sodium chloride equivalent.

(14) The food composition of (4), which is a snack, wherein the sodium chloride equivalent is 1.4% by weight or less and the total amount of the acids is 2.5 to 20.0 parts by weight, based on 100 parts by weight of the sodium chloride equivalent.

(15) The food composition of (4), which is an edible salt comprising 25% to 98% by weight of potassium chloride.

(16) The food composition of (15), wherein the total amount of the acids contained in the edible salt is 0.2 to 15.0 parts by weight, based on 100 parts by weight of the sodium chloride equivalent.

(17) The food composition according to (4), which is a dressing, in which the sodium chloride equivalent is 5.5% by weight or less and the total amount of the acids is 22.5 to 90.0 parts by weight, based on 100 parts by weight of the sodium chloride equivalent.

(18) A method of enhancing the salty taste of a food composition containing sodium chloride, which comprises a step of adding potassium chloride and at least one acid selected from acetic acid and lactic acid.

(19) A food composition comprising sodium chloride to which potassium chloride and at least one acid selected from acetic acid and lactic acid have been added.

Second Aspect of the Present Invention

The present inventors found that the offensive taste of potassium chloride would be suppressed with the use of free glutamic acid and/or free aspartic acid instead of sodium salt, thereby completing the inventions described below.

(20) A composition supplemented with potassium chloride, to which at least one selected from glutamic acid and aspartic acid has further been added, so as to suppress the offensive taste originating from potassium.

(21) A composition supplemented with potassium chloride, to which 2 to 25 parts by weight of at least one selected from glutamic acid and aspartic acid based on 100 parts by weight of potassium chloride have further been added.

(22) The composition of (20) or (21), which is any of sauce, soup, baste, soy sauce, bean paste, edible salt, seasoning, a snack, noodles, or seasoned rice.

(23) The composition of (20) or (21), which is curry sauce, in which the total of the amount of sodium chloride contained in the curry sauce and the amount of potassium chloride added in terms of an amount converted to equimolar sodium chloride (i.e., the total amount of salts) is 1.1% or less.

(24) The composition of (20) or (21), which is stew sauce, in which the total amount of salts is 0.75% by weight or less.

(25) The composition of (20) or (21), which is soup, in which the total amount of salts is 1.0% by weight or less.

(26) The composition of (20) or (21), which is a snack, in which the total amount of salts is 1.3% by weight or less.

(27) The composition of (20) or (21), which is an edible salt comprising 30% to 98% by weight of potassium chloride.

(28) A method for suppressing the offensive taste of a composition supplemented with potassium chloride comprising adding at least one selected from glutamic acid and aspartic acid to the composition so as to suppress the offensive taste originating from potassium.

This description includes part or all of the contents as disclosed in the description and/or drawings of Japanese Patent Application No. 2009-230707, which is a priority document of the present application.

### Effects of the Invention

First Aspect of the Present Invention

The first aspect of the present invention provides a food composition with reduced sodium chloride content and a reinforced salty taste or a food composition with an enhanced salty taste without increasing the amount of sodium chloride.

Second Aspect of the Present Invention

The second aspect of the present invention provides a composition suppressing the offensive taste of potassium chloride and exhibiting a salty taste similar to that of sodium chloride without imparting unnatural flavor.

The present invention provides a method for suppressing an offensive taste in a composition to which potassium chloride is added.

### EMBODIMENTS FOR CARRYING OUT THE INVENTION

1. First Aspect of the Present Invention

1.1 Acetic Acid and Lactic Acid

In the present invention, acetic acid and lactic acid are not added to a composition in the form of sodium salt. Rather, these acids are added in the state of free form. In the description and the claims of the present application, the terms “acetic acid” and “lactic acid” refer to free acetic acid and free lactic acid.

Examples of lactic acids that can be used include L-lactic acid, D-lactic acid, and a mixture thereof. All lactic acids used in the examples are L-lactic acids.

Acetic acid and lactic acid may be incorporated into a food composition as components contained in food materials. For example, acetic acid can be incorporated into a food composition in the form of an acetic acid-containing food material, such as brewed vinegar, cereal vinegar, fruit vinegar, synthetic vinegar, or wine, and lactic acid can be incorporated into a food composition in the form of a lactic-acid-containing food material, such as products of lactic acid fermentation such as wine, kimchi, Japanese pickles, pickles, yogurt, or cheese.

Acetic acid and lactic acid can be incorporated into a food composition in a powdered state.

1.2 Potassium Chloride

Potassium chloride is added to the food composition of the present invention. The amount of potassium chloride added to the food composition is not particularly limited.

1.3. Method of Reinforcing the Salty Taste and Food Composition with a Reinforced Salty Taste and Reduced Sodium Content

In the present invention, potassium chloride and at least one acid selected from acetic acid and lactic acid may be added to a food composition with reduced sodium chloride content at any step of preparation of such composition. Thus, the salty taste of the resulting food composition lowered via reduction of sodium chloride can be reinforced.

The amounts of potassium chloride and at least one acid selected from acetic acid and lactic acid added to the food composition are adequately adjusted in accordance with the amount of sodium chloride reduced and the flavor desired for the food composition, so as to reinforce the salty taste.

In the present invention, “a food composition with reduced sodium chloride content” is preferably a food composition in which sodium chloride content is 80% by weight or less, and more preferably 20% to 80% by weight, compared with the sodium chloride content of a corresponding usual food composition. The present invention is effective for such food composition.

Examples of food composition include sauce, soup, baste, soy sauce, bean paste, dressing, edible salt, seasoning, a snack, noodles, or seasoned rice.

In addition, at least one spice selected from among white pepper, black pepper, green pepper, ginger, zanthoxylum, capsicum, cumin, thyme, oregano, coriander, laurel, cardamom, mustard, cinnamon, garlic, rosemary, sage, basil, citrus unshiu peel, perilla, and lemon and/or an extract of any thereof can be added to the food composition.

When the food composition of the present invention is curry sauce, the amount of sodium contained in the curry sauce in terms of an amount converted to equimolar sodium chloride (hereafter referred to as the “sodium chloride equivalent”) is preferably 1.25% by weight or less. The total amount of at least one acid selected from acetic acid and lactic acid contained in the curry sauce is 2.6 to 52.0 parts by weight, preferably 2.6 to 23.0 parts by weight, and more preferably 2.6 to 18.0 parts by weight, based on 100 parts by weight of the sodium chloride equivalent. The sodium chloride equivalent of the curry sauce is typically 0.3% to 1.25% by weight. The potassium chloride content in the curry sauce is not particularly limited, and it is preferably 0.38% to 1.6% by weight. Curry roux used for preparing such curry sauce is within the scope of the food composition of the present invention.

When the food composition of the present invention is curry roux, the sodium chloride equivalent in the curry roux is preferably 11.5% by weight or less. The total amount of at least one acid selected from acetic acid and lactic acid contained in the curry roux is 0.8% to 17.0 parts by weight, based on 100 parts by weight of the sodium chloride equivalent. The sodium chloride equivalent of the curry roux is typically 2.8% to 11.5% by weight. The potassium chloride content in the curry roux is not particularly limited, and it is preferably 3.5% to 14.7% by weight.

When the food composition of the present invention is stew sauce, the sodium chloride equivalent is preferably 1.0% by weight or less, and the total amount of at least one acid selected from acetic acid and lactic acid contained in the stew sauce is 5.3% to 30.0 parts by weight, and preferably 5.3% to 20.0 parts by weight, based on 100 parts by weight of the sodium chloride equivalent. The sodium chloride equivalent of the stew sauce is typically 0.26% to 1.0% by weight. The potassium chloride content in the stew sauce is not particularly limited, and it is preferably 0.33% to 1.28% by weight. Stew roux used for preparing such stew sauce is within the scope of the food composition of the present invention.

When the food composition of the present invention is stew roux, the sodium chloride equivalent in the stew roux is preferably 8.5% by weight or less. The total amount of at least one acid selected from acetic acid and lactic acid contained in the stew roux is 0.7% to 17.0 parts by weight, based on 100 parts by weight of the sodium chloride equivalent. The sodium chloride equivalent of the stew roux is typically 2.1% to 8.5% by weight. The potassium chloride content in the stew roux is not particularly limited, and it is preferably 2.6% to 10.9% by weight.

When the food composition of the present invention is soup, the sodium chloride equivalent is preferably 1.3% by weight or less, and the total amount of at least one acid selected from acetic acid and lactic acid contained in the soup is 2.0 to 16.0 parts by weight, based on 100 parts by weight of the sodium chloride equivalent. The sodium chloride equivalent of the soup is typically 0.32% to 1.3% by weight. The potassium chloride content in the soup is not particularly limited, and it is preferably 0.4% to 1.66% by weight. A soup base used for preparing soup is within the scope of the food composition of the present invention.

When the food composition of the present invention is a snack, the sodium chloride equivalent is preferably 1.4% by weight or less, and the total amount of at least one acid selected from acetic acid and lactic acid contained in the snack is 2.5 to 20.0 parts by weight, based on 100 parts by weight of the sodium chloride equivalent. The sodium chloride equivalent of the snack is typically 0.36% to 1.4% by weight. The potassium chloride content in the snack is not particularly limited, and it is preferably 0.45% to 1.79% by weight.

When the food composition of the present invention is an edible salt, the edible salt preferably contains potassium chloride in an amount of 25% to 98% by weight, and more preferably 25% to 83% by weight. The term “edible salt” refers to a seasoning agent in a powdered state. The edible salt further comprises sodium chloride, in addition to potassium chloride, and at least one acid selected from acetic acid and lactic acid, and it may further comprise other seasoning agents in a powdered state. The sodium chloride equivalent of the edible salt is typically 16.0% to 74.0% by weight. More preferably, the total amount of at least one acid selected from acetic acid and lactic acid in the edible salt is 0.2 to 15.0 parts by weight, based on 100 parts by weight of the sodium chloride equivalent.

When the food composition of the present invention is a dressing, the sodium chloride equivalent is preferably 5.5% by weight or less, and the total amount of at least one acid selected from acetic acid and lactic acid contained in the dressing is 22.5 to 90.0 parts by weight, and preferably 22.5 to 63.0 parts by weight, based on 100 parts by weight of the sodium chloride equivalent. The sodium chloride equivalent of the dressing is typically 1.37% to 5.5% by weight. The potassium chloride content in the dressing is not particularly limited, and it is preferably 1.74% to 7.0% by weight.

1.4 Method of Reinforcing a Salty Taste

In the present invention, potassium chloride and at least one acid selected from acetic acid and lactic acid may be added to a food composition containing sodium chloride at any step of the preparation of such composition. Thus, the salty taste of the resulting food composition exhibited by sodium chloride can be reinforced without increasing the amount of sodium chloride.

The amounts of potassium chloride and at least one acid selected from acetic acid and lactic acid added to the food composition are adequately adjusted in accordance with the amount of sodium chloride in the food composition and flavor desired for the food composition, so as to reinforce the salty taste.

According to this embodiment of the present invention, the amount of sodium chloride contained in the food composition is a usual amount used for such food composition. Accordingly, the invention of Patent Document 6 regarding “a seasoning composition containing no or a small amount of sodium” is outside of the scope of the present invention regarding a “food composition comprising sodium chloride.” In addition, a method of enhancing a salty taste by adding lactic acid to a food composition containing sodium chloride in combination with potassium chloride, calcium salt, magnesium salt, and rice powder is excluded from the scope of the present invention.

Examples of food compositions include those similar to those described in 1.3 above.

The spice described in 1.3 above and/or an extract thereof can further be added to the food composition.

2. Second Aspect of the Present Invention

2.1. Glutamic Acid and Aspartic Acid

In the present invention, glutamic acid and aspartic acid are not added to a composition in the form of sodium salt, but these acids are added in the state of free form. In the description and the claims of the present application, the terms “glutamic acid” and “aspartic acid” refer to free glutamic acid and free aspartic acid. Glutamic acid and aspartic acid are acidic amino acids having carboxyl groups on their side chains. In a food composition with a pH of 4.25 to 9.60, hydrogen ions of side-chain carboxyl groups and α-carboxyl groups of free glutamic acid and free aspartic acid are dissociated (COO³¹ ), and amino groups have hydrogen ions (NH₃⁺).

Methods for producing free glutamic acid and free aspartic acid, properties thereof, testing methods, and the like are described in, for example, “Eighth edition, Japan's Specifications and Standards for Food Additives.” Specifically, L-glutamic acid is described in D-546 to D-547 of the document and L-aspartic acid is described in D-43 to D-45 thereof.

Examples of glutamic acids that can be used include L-glutamic acid, D-glutamic acid, and a mixture thereof.

Examples of aspartic acids that can be used include L-aspartic acid, D-aspartic acid, and a mixture thereof.

While D-glutamic acid and D-aspartic acid are not approved as food additives at present, remarkable effects thereof have been verified as described in the experiments below.

Glutamic acid and aspartic acid can be used in combination, and the amounts thereof used are not particularly limited. The amount of amino acid added is the total amount of the amino acids, when glutamic acid is used in combination with aspartic acid.

The amount of at least one selected from glutamic acid and aspartic acid added is not particularly limited, provided that such amount is sufficient for effective suppression of the offensive taste of potassium chloride. Specifically, at least one selected from glutamic acid and aspartic acid is added in an amount of 2 to 25 parts by weight based on 100 parts by weight of potassium chloride added to the composition. If the amount does not fall below the lower limit of the aforementioned range (i.e., 2 parts by weight), the offensive taste of potassium chloride can be sufficiently suppressed. If the amount does not fall above the upper limit of the aforementioned range (i.e., 25 parts by weight), acidity originating from glutamic acid or aspartic acid would not become excessively strong, and a salty taste similar to that of sodium chloride would be attained. At least one selected from glutamic acid and aspartic acid is more preferably added in an amount of 3 to 15 parts by weight, and most preferably 5 to 10 parts by weight, based on 100 parts by weight of potassium chloride added to the composition. When the amount of such substance is within the above range, effects of suppressing the offensive taste of potassium chloride would be further enhanced. In addition, acidity originating from glutamic acid or aspartic acid would be further reduced, and a composition exhibiting a salty taste more similar to that of sodium chloride can be provided.

The amount of at least one selected from glutamic acid and aspartic acid added described above is determined based on the amount of potassium chloride added during the process of preparing a composition, because artificially added potassium chloride mainly exhibits an offensive taste in a composition.

It should be noted that Patent Documents 1 to 3 do not teach that the aforementioned amount of glutamic acid or aspartic acid is added to potassium chloride incorporated into the seasoning composition.

If the total amount of potassium were added to the composition according to claim 1 of Patent Document 1 in the form of potassium chloride, the amount of potassium chloride would be 0.96% to 8.03% by mass, and the amounts of acidic amino acids incorporated would be 24.9 to 208 parts by weight based on 100 parts by weight of potassium chloride. However, the amount of potassium according to the claims of Patent Document 1 mentioned above includes the amount of substances originating from other ingredients of the seasoning agent. According to the examples of Patent Document 1, the amount of sodium salts of acidic amino acids added to 100 parts by weight of potassium chloride that causes bitterness is 33 to 315 parts by weight.

If the total amount of potassium were added to the composition according to claim 1 of Patent Document 2 in the form of potassium chloride, the amount of potassium chloride would be 0.96% to 8.03% by mass, and the amount of acidic amino acids incorporated would be 24.9 to 208 parts by weight based on 100 parts by weight of potassium chloride. However, the amount of potassium according to the claims of Patent Document 2 mentioned above includes the amount of substances originating from other ingredients of the seasoning agent. According to the examples of Patent Document 2, the amount of sodium salts of acidic amino acids added to 100 parts by weight of potassium chloride that causes bitterness is 30 to 63.3 parts by weight.

If the total amount of potassium were added to the composition according to claim 1 of Patent Document 3 in the form of potassium chloride, the amount of potassium chloride would be 0.96% to 11.47% by mass, and the amount of acidic amino acids incorporated would be 17.4 to 208 parts by weight based on 100 parts by weight of potassium chloride. However, the amount of potassium according to the claims of Patent Document 3 mentioned above includes the amount of substances originating from other ingredients of the seasoning agent. According to the examples of Patent Document 3, the amount of sodium salts of acidic amino acids added to 100 parts by weight of potassium chloride that causes bitterness is 50 to 125 parts by weight.

Thus, Patent Documents 1 to 3 teach that 30 parts by mass or more sodium salts of acidic amino acids are added to 100 parts by weight of potassium chloride added to the composition, which causes bitterness. When large quantities of sodium salts of acidic amino acids are incorporated, a flavor peculiar to sodium salts of acidic amino acids becomes strong in the composition, and the salty taste originating from sodium chloride deteriorates. If sodium salts of acidic amino acids are substituted with free acidic amino acids, acidity would disadvantageously be excessively strong.

2.2. Potassium Chloride

Potassium chloride is added to the composition of the present invention. The amount of potassium chloride to be added to the composition is not particularly limited. Typically, potassium chloride is added in an amount sufficient to substitute part or all of sodium chloride added during the process of producing existing compositions.

2.3. Composition

The composition of the present invention is intended for oral administration in the form of a food composition, or a pharmaceutical composition, and it is also intended for other purposes. The form of the composition is not particularly limited, and the composition may have a variety of forms, such as powdery, solid, semi-solid, or liquid forms. For example, a composition may be provided in the form of sauce, soup, baste, soy sauce, bean paste, edible salt, seasoning, a snack, noodles, or seasoned rice.

When the composition is in a form that is directly ingested orally by a consumer, the total amount of the weight of sodium chloride incorporated into the composition and the weight of potassium chloride added in terms of weight converted to equimolar sodium chloride (which may be occasionally referred to as the “total amount of salts” herein) is preferably 10% by weight or less, more preferably 5% by weight or less, and further preferably 2% by weight or less, based on the weight of the composition, for example. The lower limit of the total amount of salts in the composition of the present invention is not particularly limited, and it is 0.3% by weight or more based on the weight of the composition. When the composition is curry sauce, for example, the total amount of salts is preferably 1.1% by weight or less, and more preferably 0.5% to 1.1% by weight. When the composition is stew sauce, for example, the total amount of salts is preferably 0.75% by weight or less, and more preferably 0.3% to 0.75% by weight. When the composition is soup, for example, the total amount of salts is preferably 1.0% by weight or less, and more preferably 0.4% to 1.0% by weight. When the composition is a snack, for example, the total amount of salts is preferably 1.3% by weight or less, and more preferably 0.6% to 1.3% by weight. Part or all of the total amount of salts is accounted for by potassium chloride.

The composition can be in the form of an edible salt. The term “edible salt” refers to a seasoning agent in a powdered state. Preferably, potassium chloride accounts for 30% to 98% of the edible salt by weight, and other ingredients can be at least one selected from glutamic acid and aspartic acid, sodium chloride, and other powdery seasoning agents.

2.4. Method for Suppressing Bitterness

The present invention provides a method for suppressing the offensive taste of a composition supplemented with potassium chloride comprising adding at least one selected from glutamic acid and aspartic acid to the composition to suppress the offensive taste originating from potassium.

The term “composition supplemented with potassium chloride” used herein refers to a composition to which potassium chloride is added prior to, following, or simultaneously with the addition of at least one selected from glutamic acid and aspartic acid. Types, amounts to be added, formulations, and other conditions of the at least one selected from glutamic acid and aspartic acid, potassium chloride, and the composition are as described above.

### EXAMPLES

In the following experiments, L-glutamic acid, sodium glutamate, and sodium aspartate obtained from Ajinomoto Co., Inc. and L-aspartic acid obtained from Ajinomoto U.S.A. were used. D-glutamic acid and D-aspartic acid obtained from Hiroshima Wako Ltd.

were used. “Refined salt” obtained from Nihonkaisui Co., Ltd. and “potassium chloride (granules)” obtained from Tomita Pharmaceutical Co., Ltd. were used.

### Experiment 1

(Samples)

A pack (8 g) of a commercially available instant soup mix (Natural Dashinomoto (soup stock) pack, Kaneshichi Co., Ltd.) was added to 500 g of water, the mixture was heated to its boiling point, and the resultant was then decocted on medium heat for 5 minutes to prepare an instant soup mix.

Common salt (NaCl) and potassium chloride (KCl) were added to the instant soup mix in amounts of 0.55% by weight and 0.70% by weight (which was an equimolar amount of the common salt), respectively, in the mix. Specifically, the common salt equivalent in this sample was 1.1% by weight. This sample was designated as a base (Sample A).

Samples were prepared from the base by adding 7% by weight glutamic acid (Sample B), 35% by weight glutamic acid (Sample C), 7% by weight sodium glutamate (Sample D), and 35% by weight sodium glutamate (Sample E), relative to the amount of potassium chloride. The resulting samples were evaluated by 6 panelists.

A sample (a 100% common salt sample) was prepared at the time of evaluation by adding common salt (NaCl) to an amount equivalent to 1.1% of the weight of a similar instant soup mix. Samples A to E were evaluated via VAS in terms of “similarity with a 100% common salt sample,” “offensive taste,” “deliciousness,” and “acidity.” The results were analyzed via two-way analysis of variance.

(Results)

TABLE 1

| | A | B | C | D | E |
|---|---|---|---|---|---|
| Offensive taste | 6.417 | 2.833 | 1.85 | 4.167 | 4.167 |
| | | **(1%) | **(1%) | No significant | No significant |
| | | | | difference | difference |
| Deliciousness | 6.5 | 6.65 | 4.833 | 7.017 | 6.783 |
| | | No significant | No significant | No significant | No significant |
| | | difference | difference | difference | difference |
| Acidity | 1.95 | 4.667 | 10.083 | 1.7 | 2.083 |
| | | *(5%) | **(1%) | No significant | No significant |
| | | | | difference | difference |
| Similarity with | 4.2 | 6.367 | 1.567 | 5.233 | 4.3 |
| 100% salt sample | | No significant | *(5%) | No significant | No significant |
| | | difference | | difference | difference |

A: NaCl:KCl =1:1 (molar equivalent ratio; total amount of salt: 1.1%) control (with offensive taste (metallic taste peculiar to KCl))
B: A + glutamic acid (7% relative to KCl)
C: A + glutamic acid (35% relative to KCl)
D: A + sodium glutamate (7% relative to KCl)
E: A + sodium glutamate (35% relative to KCl)
Definition of numerical value for item evaluation (distance from VAS end: 0 to 12 cm)
A greater numerical value represents more enhanced “deliciousness, offensive taste, or acidity.”
Regarding “similarity with 100% salt sample,” a sample exhibiting a higher value is evaluated to have a taste more similar to that of a 100% salt sample.
Significant difference is determined in comparison with Control Sample A

(Discussion)

No significant differences were observed in terms of the offensive taste between Samples D and E to which sodium glutamate had been added and Control A (exhibiting an offensive taste). However, Samples B and C to which glutamic acid had been added were found to exhibit an offensive taste, which was significantly reduced compared with that of Control A.

Thus, it can be concluded that sodium glutamate does not have effects of reducing the offensive taste of potassium chloride while glutamic acid has effects of reducing such offensive taste.

Samples B and C to which glutamic acid had been added were found to exhibit acidity, which is significantly different from the findings for the control sample.

In terms of “similarity with a 100% common salt sample,” Sample B to which glutamic acid had been added in an amount of 7% by weight relative to the amount of potassium chloride was evaluated to exhibit the taste that was the most similar taste to the 100% common salt sample. Sample C to which glutamic acid had been added in an amount of 35% by weight relative to the amount of potassium chloride was evaluated to be significantly different. It is thus concluded that the amount of glutamic acid added is more preferably 7% by weight than 35% by weight relative to the amount of potassium chloride.

### Experiment 2

Samples (Examples 1 to 17 and Comparative Examples 1 to 9) were prepared by adding 0.55% by weight common salt (NaCl), 0.70% by weight potassium chloride (KCl), which was an equimolar amount of the common salt, and other ingredients, such as glutamic acid, in amounts as shown in Table 2, in the instant soup mix prepared in the same manner as in Experiment 1. Sensory evaluation of the resulting samples was carried out. The amount shown in Table 2 is the percentage by weight. The composition of the sample of Example 1 is the same as that of Sample B of Experiment 1, that of Comparative Example 1 is the same as Sample A of Experiment 1, that of Comparative Example 2 is the same as Sample C of Experiment 1, that of Comparative Example 4 is the same as Sample D of Experiment 1, and that of Comparative Example 5 is the same as Sample E of Experiment 1.

Sensory analysis was carried out with 4 panelists regarding whether or not the offensive taste of potassium chloride had disappeared and whether or not unnatural acidity had been exhibited.

The results are as shown below.

TABLE 2

| | Examples | | | | | | | | | |
|---|---|---|---|---|---|---|---|---|---|---|
| | 1 | 2 | 3 | 4 | 5 | 6 | 7 | 8 | 9 | 10 |
| Instant soup mix | 98.701 | 98.736 | 98.715 | 98.645 | 98.589 | 98.736 | 98.715 | 98.701 | 98.645 | 98.589 |
| NaCl | 0.55 | 0.55 | 0.55 | 0.55 | 0.55 | 0.55 | 0.55 | 0.55 | 0.55 | 0.55 |
| KCl | 0.7 | 0.7 | 0.7 | 0.7 | 0.7 | 0.7 | 0.7 | 0.7 | 0.7 | 0.7 |
| L-glutamic acid | 0.049 | 0.014 | 0.035 | 0.105 | 0.161 | — | — | — | — | — |
| Sodium glutamate | — | — | — | — | — | — | — | — | — | — |
| L-aspartic acid | — | — | — | — | — | 0.014 | 0.035 | 0.049 | 0.105 | 0.161 |
| Sodium aspartate | — | — | — | — | — | — | — | — | — | — |
| D-glutamic acid | — | — | — | — | — | — | — | — | — | — |
| D-aspartic acid | — | — | — | — | — | — | — | — | — | — |
| Taste evaluation | ⊚ | Δ | ◯ | ⊚ | ▴ | Δ | ◯ | ⊚ | ⊚ | ▴ |

| | Examples | | | | | | |
|---|---|---|---|---|---|---|---|
| | 11 | 12 | 13 | 14 | 15 | 16 | 17 |
| Instant soup mix | 98.736 | 98.715 | 98.701 | 98.645 | 98.589 | 98.701 | 98.701 |
| NaCl | 0.55 | 0.55 | 0.55 | 0.55 | 0.55 | 0.55 | 0.55 |
| KCl | 0.7 | 0.7 | 0.7 | 0.7 | 0.7 | 0.7 | 0.7 |
| L-glutamic acid | 0.007 | 0.021 | 0.021 | 0.056 | 0.091 | — | — |
| Sodium glutamate | — | — | — | — | — | — | — |
| L-aspartic acid | 0.007 | 0.014 | 0.028 | 0.049 | 0.07 | — | — |
| Sodium aspartate | — | — | — | — | — | — | — |
| D-glutamic acid | — | — | — | — | — | 0.049 | — |
| D-aspartic acid | — | — | — | — | — | — | 0.049 |
| Taste evaluation | Δ | ◯ | ⊚ | ⊚ | ▴ | ⊚ | ⊚ |

| | Comparative Examples | | | | | | | | |
|---|---|---|---|---|---|---|---|---|---|
| | 1 | 2 | 3 | 4 | 5 | 6 | 7 | 8 | 9 |
| Instant soup mix | 98.75 | 98.491 | 98.743 | 98.701 | 98.491 | 98.701 | 98.491 | 98.743 | 98.491 |
| NaCl | 0.55 | 0.55 | 0.55 | 0.55 | 0.55 | 0.55 | 0.55 | 0.55 | 0.55 |
| KCl | 0.7 | 0.7 | 0.7 | 0.7 | 0.7 | 0.7 | 0.7 | 0.7 | 0.7 |
| L-glutamic acid | — | 0.259 | 0.007 | — | — | — | — | — | — |
| Sodium glutamate | — | — | — | 0.049 | 0.259 | — | — | — | — |
| L-aspartic acid | — | — | — | — | — | — | — | 0.007 | 0.259 |
| Sodium aspartate | — | — | — | — | — | 0.049 | 0.259 | — | — |
| D-glutamic acid | — | — | — | — | — | — | — | — | — |
| D-aspartic acid | — | — | — | — | — | — | — | — | — |
| Taste evaluation | X | X | X | X | X | X | X | X | X |

⊚ Offensive taste disappeared, and flavor is preferable.
◯ Offensive taste substantially disappeared, and flavor is improved.
Δ Offensive taste begins to disappear, and flavor is acceptable.
▴ Offensive taste disappeared, flavor is acceptable, but acidity becomes strong.
X Offensive taste does not disappear, and flavor is not acceptable due to strong acidity.

### Experiment 3: Curry

Curry roux was prepared in accordance with the formulation shown in Table 3.

Oil was heated in a frying pan, and wheat flour was then introduced and sauted therein. When the wheat flour was sauted until golden brown (reached 130° C.), the frying pan was removed from the heat, and curry powder was added thereto and sauted with residual heat. Thus, curry roux was obtained.

Subsequently, curry samples 1 to 3 were prepared in accordance with the formulation shown in Table 4. At the outset, meat and vegetables were cut into appropriate sizes, and onions, meat, potatoes, and carrots were successively sauted in oil. Thereafter, water was added thereto, and the resultant was decocted.

Curry roux was diluted via boiling, simmered with other ingredients on low heat, and seasoned with common salt and sugar.

TABLE 3 [symbol]
Roux

[symbol]

| | |
|---|---|
| Wheat flour | 300 |
| Oil (modified lard) | 240 |
| Curry powder | 56 |
| Total | 596 |

Unit: g

TABLE 4 [symbol]
Final

[symbol]

| | Curry 1 | Curry 2 | Curry 3 |
|---|---|---|---|
| Beef | 150 | 150 | 150 |
| Onion | 2 medium- | 2 medium- | 2 medium- |
| | size | size | size |
| Potato | 1 large- | 1 large- | 1 large- |
| | size | size | size |
| Carrot | 1 small- | 1 small- | 1 small- |
| | size | size | size |
| Curry roux | 80 | 80 | 80 |
| Common salt | 11 | 5.5 | 5.5 |
| Potassium chloride | 0 | 7 | 7 |
| Glutamic acid | 0 | 0 | 0.245 |
| Aspartic acid | 0 | 0 | 0.245 |
| Sugar | 8.8 | 8.8 | 8.8 |
| Water | 700 | 700 | 700 |

Unit: g

Evaluation results for the cooked curry samples 1 to 3 were as described below.

Curry sample 1 (NaCl only): While this sample is ill-balanced in terms of deliciousness and acidity, there are no problems in terms of flavor.

Curry sample 2 (NaCl:KCl=1:1 (molar ratio)): This sample was insufficient in terms of tastes such as deliciousness, and a taster began to sense an offensive taste at both sides under the tongue in the middle of ingestion and continued to sense an offensive taste later on.

Curry sample 3 (NaCl:KCl=1:1 (molar ratio); 3.5% by weight each glutamic acid and aspartic acid relative to KCl): While the sample was insufficient in terms of the taste, the offensive taste had disappeared.

Evaluation results for the curry samples 1 to 3, which had been subjected to retort heat sterilization at 122° C. for 25 minutes, are as described below.

Curry sample 1 (NaCl only): While this sample lacks some taste, as with the sample before cooking, it has no problems in terms of flavor.

Curry sample 2 (NaCl:KCl=1:1 (molar ratio)): This sample was insufficient in terms of tastes such as deliciousness, and a taster began to sense an offensive taste at both sides under the tongue in the middle of ingestion and continued to sense, an offensive taste later on.

Curry sample 3 (NaCl:KCl=1:1 (molar ratio); 3.5% by weight each glutamic acid and aspartic acid relative to KCl): While the sample was insufficient in terms of tastes, the offensive taste had disappeared.

### Experiment 4: Stew

Stew roux was prepared in accordance with the formulation shown in Table 5. Butter was heated in a frying pan, and wheat flour was then introduced and sauted therein. Sauteing was terminated when the raw flavor of the flour had been cooked out and the resultant smelled like a cookie (approximately 130° C.). Subsequently, the resultant was cooled with icy water.

Bechamel sauce was prepared using the resulting stew roux in accordance with the formulation shown in Table 6. At the outset, the roux was mixed with milk at the melting temperature of butter or higher and the gelatinization temperature of wheat flour or lower. When the raw flavor of the flour had been cooked out and the sauce became glazed, the sauce sample was strained through chinois to complete the bechamel sauce. The yield was 1,600 g.

Subsequently, stew samples 1 to 3 were prepared in accordance with the formulation shown in Table 7. Chicken and vegetables were cut into appropriate sizes, and chicken was first sauted in a frying pan. Onions, potatoes, and carrots were sauted in the same frying pan. Ingredients and the bechamel sauce were added to the pot, diluted with hot water (glutamic acid and aspartic acid were introduced thereinto), and seasoned with common salt, potassium chloride, and pepper. Thus, stew samples were prepared.

TABLE 5 [symbol]
Roux

[symbol]

| | |
|---|---|
| Wheat flour | 300 |
| Salt-free butter | 255 |

Unit: g

TABLE 6 [symbol]
Bechamel sauce

[symbol]

| | |
|---|---|
| Roux | 266 |
| Milk | 2000 |

Unit: g

TABLE 7 [symbol]
Final

[symbol]

| | Stew 1 | Stew 2 | Stew 3 |
|---|---|---|---|
| Chicken | 150 | 150 | 150 |
| Onion | 2 medium- | 2 medium- | 2 medium- |
| | sized | sized | sized |
| Potato | 1 large- | 1 large- | 1 large- |
| | size | size | size |
| Carrot | 1 small- | 1 small- | 1 small- |
| | size | size | size |
| Bechamel sauce | 450 | 450 | 500 |
| Common salt | 9 | 4.5 | 4.5 |
| Potassium chloride | 0 | 5.73 | 5.73 |
| Glutamic acid | 0 | 0 | 0.20 |
| Aspartic acid | 0 | 0 | 0.20 |
| White pepper | A little | A little | A little |
| Boiled water | 300 | 300 | 300 |

Unit: g

Evaluation results for the cooked stew samples 1 to 3 are as described below. Stew sample 1: (NaCl only): This sample was free from problems.

Stew sample 2 (NaCl:KCl=1:1 (molar ratio)): This sample was insufficient in terms of tastes such as deliciousness, and the taster began to sense an offensive taste at both sides under the tongue in the middle of ingestion. The offensive taste was apparently stronger than that of a curry sample.

Stew sample 3 (NaCl:KCl=1:1 (molar ratio); 3.5% by weight each glutamic acid and aspartic acid relative to KCl): While the sample was insufficient in terms of tastes such as deliciousness, an offensive taste had disappeared.

Evaluation results for the stew samples 1 to 3, which had been subjected to retort heat sterilization at 122° C. for 25 minutes, are as described below.

Stew sample 1 (NaCl only): While a flavor resulting from browning caused by retort sterilization remained, it was insignificant.

Stew sample 2 (NaCl:KCl=1:1 (molar ratio)): This sample was also insufficient in terms of deliciousness. While an offensive taste had somewhat disappeared compared with conditions before cooking, an offensive taste increased after several bites.

Stew sample 3 (NaCl:KCl=1:1 (molar ratio); 3.5% by weight each glutamic acid and aspartic acid relative to KCl): This sample was also insufficient in terms of deliciousness. An offensive taste did not appear even when the taster continued to eat the sample.

### Experiment 5: Ramen Soup

Chicken broth was prepared in accordance with the formulation shown in Table 8. At the outset, chicken was introduced into water, heated on high heat, and boiled, followed by removal of the resulting scum. Thereafter, green onions were added and decocted on low heat. The resultant was decocted for 1.5 hours and strained after the taste had appeared. Thus, chicken broth was obtained (yield: 2,250 g).

The obtained chicken broth and other ingredients were mixed with one another in accordance with the formulations shown in Table 9. Thus, ramen soup samples 1 to 3 were obtained.

TABLE 8 [symbol]
Chicken broth

[symbol]

| | |
|---|---|
| Chicken | 1000 |
| Green part of green onion | 60 (2 to 3 |
| | green onion) |
| Ginger | 15 |
| Water | 3000 |

Unit: g

TABLE 9 [symbol]
Soy sauce ramen soup

[symbol]

| | Soup 1 | Soup 2 | Soup 3 |
|---|---|---|---|
| Chicken broth | 500 | 500 | 500 |
| P enriched soy sauce (14.6%) | 24 | 24 | 24 |
| Common salt | 3.5 | 0 | 0 |
| Potassium chloride | 0 | 4.46 | 4.46 |
| Glutamic acid | 0 | 0.000 | 0.156 |
| Aspartic acid | 0 | 0.000 | 0.156 |
| Total | 527.5 | 528.46 | 528.7722 |

Unit: g

Evaluation results for ramen soup samples 1 to 3 are as described below.

Soup sample 1 (NaCl only): This sample was free from problems.

Soup sample 2 (NaCl:KCl=1:1 (molar ratio)): This sample was insufficient in terms of tastes such as deliciousness, as with the stew and curry samples. The aroma of chicken broth was also reduced. The taster began to sense an offensive taste at both sides under the tongue and continued to sense an offensive taste.

Soup sample 3 (NaCl:KCl=1:1 (molar ratio); 3.5% by weight each glutamic acid and aspartic acid relative to KCl): This sample was also insufficient in terms of tastes such as deliciousness. No offensive taste was sensed, but a salty taste seemed to be somewhat increased. A chicken broth flavor was also strong.

### Experiment 6: Edible Salt (French Fries)

Ingredients were mixed with one another in accordance with the formulations shown in Table 10 to prepare the edible salt samples 1 to 3.

TABLE 10 [symbol]
Edible salt for french fries

[symbol]

| | Edible | Edible | Edible |
|---|---|---|---|
| | salt 1 | salt 2 | salt 3 |
| Common salt | 58.5 | 29.25 | 29.25 |
| Potassium chloride | 0 | 37.27 | 37.27 |
| Glutamic acid | 0 | 0 | 1.304 |
| Aspartic acid | 0 | 0 | 1.304 |
| Total | 58.5 | 66.52 | 69.1289 |

Unit: g

The edible salt samples 1 to 3 were applied to fried french fries and ingested. Results of evaluation are as described below.

Edible salt sample 1 (NaCl only): This sample was free from problems.

Edible salt sample 2 (NaCl:KCl=1:1 (molar ratio)): While this sample was not impossible to eat, an offensive taste increased when a person continued to ingest the same. It was not possible to ingest a large quantity thereof.

Edible salt sample 3 (NaCl:KCl=1:1 (molar ratio); 3.5% by weight each glutamic acid and aspartic acid relative to KCl): An offensive taste had disappeared. The sample was ingestible without resistance.

### Experiment 7: Retort Curry

Wheat flour roux was prepared in accordance with the formulation shown in Table 11.

Lard was melted at 60° C., wheat flour was added thereto, and the mixture was heated to 130° C. Thereafter, curry powder was added and sauted with residual heat. Thus, wheat flour roux was obtained.

Subsequently, retort curry samples were prepared in accordance with the formulation shown in Table 12. At the outset, the amounts of the starting materials shown in Table 12, excluding boiled beef, carrots, and potatoes, was measured, these materials were mixed, and the resulting mixture was then heated to 95° C. The heated sauce, boiled beef, carrots, and potatoes were introduced into a retort pouch and subjected to retort sterilization at 122° C. for 25 minutes. Thus, the samples were evaluated, and the results of evaluation are shown in Table 12.

It should be noted that the term “numerical values” used in the tables exhibiting formulations relates to figures for mass unless otherwise specified (unit: g). The same applies to Tables 8 to 14 below.

The term “amount of acetic acid and lactic acid/sodium chloride” used in the tables refers to the total amount of acetic acid and lactic acid relative to the sodium chloride equivalent (1 part by weight).

TABLE 11
(Wheat flour roux)

| | |
|---|---|
| Wheat flour | 540 |
| Lard | 500 |
| Curry powder | 110 |
| Total | 1150 |

TABLE 12
(Curry sauce formulation)

| | | Comparative | Comparative | | | | | | |
|---|---|---|---|---|---|---|---|---|---|
| | Cont. | Example 1 | Example 2 | Example 1 | Example 2 | Example 3 | Example 4 | Example 5 | Example 6 |
| Wheat flour roux | 20 | 20 | 20 | 20 | 20 | 20 | 20 | 20 | 20 |
| Superfine sugar | 4.7 | 4.67 | 4.67 | 4.67 | 4.67 | 4.67 | 4.67 | 4.67 | 4.67 |
| Tomato paste | 2.67 | 2.67 | 2.67 | 2.67 | 2.67 | 2.67 | 2.67 | 2.67 | 2.67 |
| Apple paste | 2.67 | 2.67 | 2.67 | 2.67 | 2.67 | 2.67 | 2.67 | 2.67 | 2.67 |
| Common salt | 2.40 | 1.68 | 1.68 | 1.68 | 1.68 | 1.68 | 1.68 | 1.68 | 1.68 |
| Potassium chloride | 0 | 0 | 0.91 | 0.91 | 0.91 | 0.91 | 0.91 | 0.91 | 0.91 |
| Sodium glutamate | 1.07 | 1.07 | 1.07 | 1.07 | 1.07 | 1.07 | 1.07 | 1.07 | 1.07 |
| Yeast extract | 1.07 | 1.07 | 1.07 | 1.07 | 1.07 | 1.07 | 1.07 | 1.07 | 1.07 |
| Sauteed onion | 4 | 4 | 4 | 4 | 4 | 4 | 4 | 4 | 4 |
| Garlic powder | 0.13 | 0.13 | 0.13 | 0.13 | 0.13 | 0.13 | 0.13 | 0.13 | 0.13 |
| Water | 121.33 | 122.08 | 121.17 | 121.17 | 121.17 | 121.17 | 121.17 | 121.17 | 121.17 |
| Acetic acid powder | | | 0.0036 | 0.0072 | 0.018 | 0.0288 | | | 0.032 |
| Fermentation lactic acid | | | | | | | 0.05 | 0.072 | 0.043 |
| Boiled beef | 10 | 10 | 10 | 10 | 10 | 10 | 10 | 10 | 10 |
| Carrot | 10 | 10 | 10 | 10 | 10 | 10 | 10 | 10 | 10 |
| Potato | 20 | 20 | 20 | 20 | 20 | 20 | 20 | 20 | 20 |
| Total | 200 | 200 | 200.0 | 200 | 200 | 200 | 200 | 200 | 200 |
| Evaluation | ⊚ | X | X | Δ | ◯ | ⊚ | ⊚ | ⊚ | ⊚ |
| Acetic acid (mg/100 g) | 2 | 2 | 3.51 | 5.02 | 9.54 | 14.07 | 2.00 | 2.00 | 15.41 |
| Lactic acid (mg/100 g) | 25 | 25 | 25 | 25 | 25 | 25 | 37.5 | 43 | 35.75 |
| Na(g/100 g) | 0.593 | 0.451 | 0.451 | 0.452 | 0.452 | 0.453 | 0.451 | 0.451 | 0.454 |
| Sodium chloride equivalent (g/100 g) | 1.51 | 1.15 | 1.15 | 1.15 | 1.15 | 1.15 | 1.15 | 1.15 | 1.15 |
| Amount of acetic acid and lactic acid/ | 0.018 | 0.024 | 0.025 | 0.026 | 0.030 | 0.034 | 0.034 | 0.039 | 0.044 |
| sodium chloride | | | | | | | | | |

| | | | | Example | Example | Example | Example | Example | Example | Example |
|---|---|---|---|---|---|---|---|---|---|---|
| | Example 7 | Example 8 | Example 9 | 10 | 11 | 12 | 13 | 14 | 15 | 16 |
| Wheat flour roux | 20 | 20 | 20 | 20 | 20 | 20 | 20 | 20 | 20 | 20 |
| Superfine sugar | 4.67 | 4.67 | 4.67 | 4.67 | 4.67 | 4.67 | 4.67 | 4.67 | 4.67 | 4.67 |
| Tomato paste | 2.67 | 2.67 | 2.67 | 2.67 | 2.67 | 2.67 | 2.67 | 2.67 | 2.67 | 2.67 |
| Apple paste | 2.67 | 2.67 | 2.67 | 2.67 | 2.67 | 2.67 | 2.67 | 2.67 | 2.67 | 2.67 |
| Common salt | 1.44 | 1.44 | 1.44 | 1.2 | 1.2 | 1.2 | 1.2 | 1.2 | 1.2 | 1.44 |
| Potassium chloride | 1.22 | 1.22 | 1.22 | 1.52 | 1.52 | 1.52 | 1.52 | 1.52 | 1.52 | 1.224 |
| Sodium glutamate | 1.07 | 1.07 | 1.07 | 1.07 | 1.07 | 1.07 | 1.07 | 1.07 | 1.07 | 1.07 |
| Yeast extract | 1.07 | 1.07 | 1.07 | 1.07 | 1.07 | 1.07 | 1.07 | 1.07 | 1.07 | 1.07 |
| Sauteed onion | 4 | 4 | 4 | 4 | 4 | 4 | 4 | 4 | 4 | 4 |
| Garlic powder | 0.13 | 0.13 | 0.13 | 0.13 | 0.13 | 0.13 | 0.13 | 0.13 | 0.13 | 0.13 |
| Water | 121.07 | 121.07 | 121.07 | 121.01 | 121.01 | 121.01 | 121.01 | 121.01 | 121.01 | 121.07 |
| Acetic acid powder | 0.048 | | 0.043 | 0.066 | | 0.048 | 0.09 | 0.144 | 0.18 | 0.029 |
| Fermentation lactic acid | | 0.08 | 0.058 | | 0.108 | 0.06 | 0.12 | 0.192 | 0.24 | 0.038 |
| White pepper powder | | | | | | | | | | 0.020 |
| Boiled beef | 10 | 10 | 10 | 10 | 10 | 10 | 10 | 10 | 10 | 10 |
| Carrot | 10 | 10 | 10 | 10 | 10 | 10 | 10 | 10 | 10 | 10 |
| Potato | 20 | 20 | 20 | 20 | 20 | 20 | 20 | 20 | 20 | 20 |
| Total | 200 | 200 | 200 | 200 | 200 | 200 | 200 | 200 | 200 | 200 |
| Evaluation | ⊚ | ⊚ | ⊚ | ⊚ | ⊚ | ⊚ | ◯ | Δ | Δ | ⊚ |
| Acetic acid (mg/100 g) | 22.12 | 2.00 | 20.02 | 29.66 | 2.00 | 22.12 | 39.72 | 62.35 | 77.44 | 14.15 |
| Lactic acid (mg/100 g) | 25 | 45 | 39.5 | 25 | 52 | 40 | 55 | 73 | 85 | 34.5 |
| Na(g/100 g) | 0.408 | 0.404 | 0.407 | 0.362 | 0.357 | 0.361 | 0.364 | 0.369 | 0.372 | 0.406 |
| Sodium chloride | 1.04 | 1.03 | 1.04 | 0.92 | 0.91 | 0.92 | 0.93 | 0.94 | 0.94 | 1.03 |
| equivalent (g/100 g) | | | | | | | | | | |
| Amount of acetic aci | 0.045 | 0.046 | 0.057 | 0.059 | 0.060 | 0.068 | 0.102 | 0.144 | 0.172 | 0.047 |
| d and lactic acid/ | | | | | | | | | | |
| sodium chloride | | | | | | | | | | |

Potassium chloride, Tomita Pharmaceutical Co., Ltd.
Acetic acid powder (42.3% acetic acid and 57.7% sodium acetate), Nippon Synthetic Chemical Industry Co., Ltd Fermentation lactic acid (50% lactic acid), Purac Japan
⊚: A salty taste with a good balance is maintained as a whole (from initial taste to aftertaste).
◯: A salty taste is sufficient as a whole (from initial taste to aftertaste).
Δ: A salty taste is insufficient but acceptable as a whole, although there is acceptable acidity.
X: A salty taste is insufficient, or acidity is excessive.

### Experiment 8: Retort Stew

Retort stew samples were prepared in accordance with the formulation shown in Table 13. At the outset, the raw materials shown in Table 13 except for boiled chicken, carrots, and potatoes were measured and mixed, and the resulting mixture was heated to 95° C. The heated sauce, boiled chicken, carrots, and potatoes were inserted into a retort pouch, subjected to retort sterilization at 122° C. for 25 minutes, and then evaluated. The results are shown in Table 13.

TABLE 13
(Stew sauce formulation)

| | | Comparative | Comparative | | | | | | |
|---|---|---|---|---|---|---|---|---|---|
| | Cont | Example 1 | Example 2 | Example 1 | Example 2 | Example 3 | Example 4 | Example 5 | Example 6 |
| Bechamel sauce roux | 11.2 | 11.2 | 11.2 | 11.2 | 11.2 | 11.2 | 11.2 | 11.2 | 11.2 |
| Common salt | 1.4 | 0.98 | 0.98 | 0.98 | 0.98 | 0.98 | 0.98 | 0.98 | 0.98 |
| Potassium chloride | 0 | 0 | 0.53 | 0.53 | 0.53 | 0.53 | 0.53 | 0.53 | 0.53 |
| Granulated sugar | 2.1 | 2.1 | 2.1 | 2.1 | 2.1 | 2.1 | 2.1 | 2.1 | 2.1 |
| Yeast extract | 0.07 | 0.07 | 0.07 | 0.07 | 0.07 | 0.07 | 0.07 | 0.07 | 0.07 |
| Sodium glutamate | 0.84 | 0.84 | 0.84 | 0.84 | 0.84 | 0.84 | 0.84 | 0.84 | 0.84 |
| Vegetable oil and fat cream | 28 | 28 | 28 | 28 | 28 | 28 | 28 | 28 | 28 |
| Cheese powder | 0.7 | 0.7 | 0.7 | 0.7 | 0.7 | 0.7 | 0.7 | 0.7 | 0.7 |
| Fresh cream | 2.8 | 2.8 | 2.8 | 2.8 | 2.8 | 2.8 | 2.8 | 2.8 | 2.8 |
| Sauteed onion | 5.6 | 5.6 | 5.6 | 5.6 | 5.6 | 5.6 | 5.6 | 5.6 | 5.6 |
| Water | 87.29 | 87.71 | 87.18 | 87.18 | 87.18 | 87.18 | 87.18 | 87.18 | 87.18 |
| Acetic acid powder | | | 0.0021 | 0.004 | 0.013 | 0.018 | | | 0.019 |
| Fermentation lactic acid | | | | | | | 0.032 | 0.038 | 0.025 |
| Boiled chicken | 20 | 20 | 20 | 20 | 20 | 20 | 20 | 20 | 20 |
| Carrot | 20 | 20 | 20 | 20 | 20 | 20 | 20 | 20 | 20 |
| Potato | 20 | 20 | 20 | 20 | 20 | 20 | 20 | 20 | 20 |
| Total | 200 | 200 | 200 | 200 | 200 | 200 | 200 | 200 | 200 |
| Evaluation | ⊚ | X | X | Δ | ◯ | ⊚ | ⊚ | ⊚ | ⊚ |
| Acetic acid (mg/100 g) | 1 | 1 | 1.88 | 2.68 | 6.45 | 8.54 | 1.00 | 1.00 | 8.96 |
| Lactic acid (mg/100 g) | 38 | 38 | 38 | 38 | 38 | 38 | 46 | 47.45 | 44.25 |
| Na (g/100 g) | 0.382 | 0.299 | 0.299 | 0.299 | 0.300 | 0.300 | 0.299 | 0.299 | 0.301 |
| Sodium chloride equivalent (g/100 g) | 0.971 | 0.761 | 0.760 | 0.761 | 0.763 | 0.764 | 0.760 | 0.760 | 0.764 |
| Amount of acetic acid and lactic | 0.040 | 0.051 | 0.052 | 0.053 | 0.058 | 0.061 | 0.062 | 0.064 | 0.070 |
| acid/sodium chloride | | | | | | | | | |

| | | | | Example | Example | Example | Example | Example | Example | Example |
|---|---|---|---|---|---|---|---|---|---|---|
| | Example 7 | Example 8 | Example 9 | 10 | 11 | 12 | 13 | 14 | 15 | 16 |
| Bechamel sauce roux | 11.2 | 11.2 | 11.2 | 11.2 | 11.2 | 11.2 | 11.2 | 11.2 | 11.2 | 11.2 |
| Common salt | 0.84 | 0.84 | 0.84 | 0.7 | 0.7 | 0.7 | 0.7 | 0.7 | 0.7 | 0.84 |
| Potassium chloride | 0.71 | 0.71 | 0.71 | 0.89 | 0.89 | 0.89 | 0.89 | 0.89 | 0.89 | 0.71 |
| Granulated sugar | 2.1 | 2.1 | 2.1 | 2.1 | 2.1 | 2.1 | 2.1 | 2.1 | 2.1 | 2.1 |
| Yeast extract | 0.07 | 0.07 | 0.07 | 0.07 | 0.07 | 0.07 | 0.07 | 0.07 | 0.07 | 0.07 |
| Sodium glutamate | 0.84 | 0.84 | 0.84 | 0.84 | 0.84 | 0.84 | 0.84 | 0.84 | 0.84 | 0.84 |
| Vegetable oil and fat cream | 28 | 28 | 28 | 28 | 28 | 28 | 28 | 28 | 28 | 28 |
| Cheese powder | 0.7 | 0.7 | 0.7 | 0.7 | 0.7 | 0.7 | 0.7 | 0.7 | 0.7 | 0.7 |
| Fresh cream | 2.8 | 2.8 | 2.8 | 2.8 | 2.8 | 2.8 | 2.8 | 2.8 | 2.8 | 2.8 |
| Sauteed onion | 5.6 | 5.6 | 5.6 | 5.6 | 5.6 | 5.6 | 5.6 | 5.6 | 5.6 | 5.6 |
| Water | 87.14 | 87.14 | 87.14 | 87.10 | 87.10 | 87.10 | 87.10 | 87.10 | 87.10 | 87.14 |
| Acetic acid powder | 0.028 | | 0.025 | 0.035 | | 0.032 | 0.050 | 0.084 | 0.105 | 0.019 |
| Fermentation lactic acid | | 0.05 | 0.034 | | 0.06 | 0.042 | 0.067 | 0.112 | 0.14 | 0.025 |
| White pepper powder | | | | | | | | | | 0.02 |
| Boiled chicken | 20 | 20 | 20 | 20 | 20 | 20 | 20 | 20 | 20 | 20 |
| Carrot | 20 | 20 | 20 | 20 | 20 | 20 | 20 | 20 | 20 | 20 |
| Potato | 20 | 20 | 20 | 20 | 20 | 20 | 20 | 20 | 20 | 20 |
| Total | 200 | 200 | 200 | 200 | 200 | 200 | 200 | 200 | 200 | 200 |
| Evaluation | ⊚ | ⊚ | ⊚ | ⊚ | ⊚ | ⊚ | ◯ | Δ | Δ | ⊚ |
| Acetic acid (mg/100 g) | 12.74 | 1.00 | 11.48 | 15.67 | 1.00 | 14.41 | 21.96 | 36.21 | 45.01 | 8.96 |
| Lactic acid (mg/100 g) | 38 | 50.5 | 46.5 | 38 | 53 | 48.5 | 54.75 | 66 | 73 | 44.25 |
| Na (g/100 g) | 0.274 | 0.272 | 0.274 | 0.247 | 0.244 | 0.247 | 0.248 | 0.251 | 0.252 | 0.301 |
| Sodium chloride equivalent | 0.697 | 0.691 | 0.696 | 0.627 | 0.620 | 0.627 | 0.630 | 0.637 | 0.642 | 0.764 |
| (g/100 g) | | | | | | | | | | |
| Amount of acetic acid and | 0.073 | 0.075 | 0.083 | 0.086 | 0.087 | 0.100 | 0.122 | 0.160 | 0.184 | 0.070 |
| lactic acid/sodium chloride | | | | | | | | | | |

Potassium chloride, Tomita Pharmaceutical Co., Ltd.
Acetic acid powder (42.3% acetic acid and 57.7% sodium acetate), Nippon Synthetic Chemical Industry Co., Ltd
Fermentation lactic acid (50% lactic acid), Purac Japan
Evaluation indicators in Table 13
⊚: A salty taste with a good balance is maintained as a whole (from initial taste to aftertaste).
◯: A salty taste is sufficient as a whole (from initial taste to aftertaste).
Δ: A salty taste is insufficient but acceptable as a whole, although there is acceptable acidity.
X: A salty taste is insufficient, or acidity is excessive.

### Experiment 9: Curry Roux

Curry roux was prepared in accordance with the following procedure.

The raw materials shown in Table 14 were mixed to prepare the first formulation, and the stock formulation shown in Table 15 was prepared using the same. The raw materials shown in Table 16 were mixed to prepare a powder mixture. The raw materials shown in Table 17 were mixed, and the mixture was heated to 115° C. for 30 minutes to prepare wheat flour roux.

Curry roux was prepared in accordance with the final formulation shown in Table 18. A mixture of beef fat and lard and wheat flour roux was introduced, and the resultant was heated to 95° C. When the temperature reached 95° C., curry powder, the stock formulation, and the powder mixture were introduced. Heating was terminated at 105° C. The heated mixture was solidified via cooling to obtain roux, 300 g of hot water was added to 40 g of the resulting roux, the roux was dissolved via heating, and the resultants were heated to the boiling point, followed by evaluation. The results of evaluation are shown in Table 19.

TABLE 14
(First formulation)

| | | Comparative | | | | | | | Comparative |
|---|---|---|---|---|---|---|---|---|---|
| | Cont. | Example 1 | Example 1 | Example 2 | Example 3 | Example 4 | Example 5 | Example 6 | Example 2 |
| Cheese powder | 0.3 | 0.3 | 0.3 | 0.3 | 0.3 | 0.3 | 0.3 | 0.3 | 0.3 |
| Sodium inosinate | 1.4 | 1.4 | 1.4 | 1.4 | 1.4 | 1.4 | 1.4 | 1.4 | 1.4 |
| Onion powder | 22 | 22 | 22 | 22 | 22 | 22 | 22 | 22 | 22 |
| Citric acid | 4 | 4 | 4 | 4 | 4 | 4 | 4 | 4 | 4 |
| Caramel powder | 100 | 100 | 100 | 100 | 100 | 100 | 100 | 100 | 100 |
| Garlic powder | 5 | 5 | 5 | 5 | 5 | 5 | 5 | 5 | 5 |
| Yeast extract | 23 | 23 | 23 | 23 | 23 | 23 | 23 | 3 | 23 |
| Defatted soy flour | 16 | 16 | 16 | 16 | 16 | 16 | 16 | 16 | 16 |
| Dextrin | 40 | 40 | 40 | 40 | 40 | 40 | 40 | 40 | 40 |
| Total | 211.7 | 211.7 | 211.7 | 211.7 | 211.7 | 211.7 | 211.7 | 211.7 | 211.7 |

TABLE 15
(Stock formulation)

| | | Comparative | | | | | | | Comparative |
|---|---|---|---|---|---|---|---|---|---|
| | Cont. | Example 1 | Example 1 | Example 2 | Example 3 | Example 4 | Example 5 | Example 6 | Example 2 |
| First formulation | 65 | 65 | 65 | 65 | 65 | 65 | 65 | 65 | 65 |
| Dextrin | 7 | 7 | 7 | 7 | 7 | 7 | 7 | 7 | 7 |
| Sodium glutamate | 40 | 40 | 40 | 40 | 40 | 40 | 40 | 40 | 40 |
| Total | 112 | 112 | 112 | 112 | 112 | 112 | 112 | 112 | 112 |

TABLE 16
(Mixed powder)

| | | Comparative | | | | | | | Comparative |
|---|---|---|---|---|---|---|---|---|---|
| | Cont. | Example 1 | Example 1 | Example 2 | Example 3 | Example 4 | Example 5 | Example 6 | Example 2 |
| Common salt | 180 | 108 | 108 | 108 | 108 | 108 | 90 | 90 | 90 |
| Corn starch | 210 | 210 | 210 | 210 | 210 | 210 | 210 | 210 | 210 |
| Dextrin | 60.45 | 132.45 | 39.35 | 34.15 | 32.65 | 26.35 | 16.25 | 9.75 | 0 |
| Potassium chloride | 0 | 0 | 91.8 | 91.8 | 91.8 | 91.8 | 114.7 | 114.7 | 114.7 |
| Granulated sugar | 200 | 200 | 200 | 200 | 200 | 200 | 200 | 200 | 200 |
| Acetic acid powder | 0 | 0 | 0.6 | 3 | 3 | 6.6 | 9 | 12 | 16.5 |
| Lactic acid powder | 0 | 0 | 0.7 | 3.5 | 3.5 | 7.7 | 10.5 | 14 | 19.3 |
| White pepper powder | 0 | 0 | 0 | 0 | 1.5 | 0 | 0 | 0 | 0 |
| Total | 650.45 | 650.45 | 650.45 | 650.45 | 650.45 | 650.45 | 650.45 | 650.45 | 650.45 |

TABLE 17
(Wheat flour roux)

| | | Comparative | | | | | | | Comparative |
|---|---|---|---|---|---|---|---|---|---|
| | Cont. | Example 1 | Example 1 | Example 2 | Example 3 | Example 4 | Example 5 | Example 6 | Example 2 |
| Wheat flour | 190 | 190 | 190 | 190 | 190 | 190 | 190 | 190 | 190 |
| Mixture of beef fat and lard | 190 | 190 | 190 | 190 | 190 | 190 | 190 | 190 | 190 |
| Total | 380 | 380 | 380 | 380 | 380 | 380 | 380 | 380 | 380 |

TABLE 18
(Final formulation)

| | | Compar- | | | | | | | |
|---|---|---|---|---|---|---|---|---|---|
| | | ative | | | | | | | Comparative |
| | Cont. | Example 1 | Example 1 | Example 2 | Example 3 | Example 4 | Example 5 | Example 6 | Example 2 |
| Mixture of beef fat and lard | 310 | 310 | 310 | 310 | 310 | 310 | 310 | 310 | 310 |
| Wheat flour roux | 380 | 380 | 380 | 380 | 380 | 380 | 380 | 380 | 380 |
| Stock formulation | 112 | 112 | 112 | 112 | 112 | 112 | 112 | 112 | 112 |
| Mixed powder | 650.45 | 650.45 | 650.45 | 650.45 | 650.45 | 650.45 | 650.45 | 650.45 | 650.45 |
| Curry powder | 120 | 120 | 120 | 120 | 120 | 120 | 120 | 120 | 120 |
| Total | 1572.45 | 1572.45 | 1572.45 | 1572.45 | 1572.45 | 1572.45 | 1572.45 | 1572.45 | 1572.45 |
| Evaluation | ⊚ | X | ◯ | ⊚ | ⊚ | ⊚ | ◯ | Δ | X |
| Acetic acid (mg/100 g) | 30 | 30 | 61.98 | 189.92 | 189.92 | 381.82 | 509.76 | 669.68 | 909.56 |
| Lactic acid (mg/100 g) | 18 | 18 | 55.01 | 203.04 | 203.04 | 425.09 | 573.12 | 758.16 | 1035.71 |
| Na (g/100 g) | 5.58 | 3.78 | 3.78 | 3.81 | 3.81 | 3.85 | 3.44 | 3.47 | 3.52 |
| Sodium chloride equivalent | 14.19 | 9.61 | 9.63 | 9.69 | 9.69 | 9.78 | 8.76 | 8.83 | 8.95 |
| (g/100 g) | | | | | | | | | |
| Amount of acetic acid and | 0.003 | 0.005 | 0.012 | 0.041 | 0.041 | 0.082 | 0.124 | 0.162 | 0.217 |
| lactic acid/sodium chloride | | | | | | | | | |

TABLE 19 [symbol]
Evaluation

[symbol]

| | | |
|---|---|---|
| Cont. | Curry flavored with mild spices | ⊚ |
| Comparative | Salty taste is lost, and flavor is | X |
| Example 1 | weakened as a whole, with a sense | |
| | of something missing. | |
| Example 1 | A salty taste is complemented | ◯ |
| | (from initial taste to aftertaste). | |
| Example 2 | A salty taste with a good balance | ⊚ |
| | is maintained as a whole (from | |
| | initial taste to aftertaste) | |
| Example 3 | Rise of the initial taste becomes | ⊚ |
| | strong, and taste coherence is | |
| | further improved, in addition to | |
| | properties of Example 2. | |
| Example 4 | A salty taste with a good balance is | ⊚ |
| | maintained as a whole (from initial | |
| | taste to aftertaste) | |
| Example 5 | A salty taste is sufficient as a whole, | ◯ |
| | although there is mild acidity. | |
| Example 6 | A salty taste is complemented as a | Δ |
| | whole with acceptable acidity. | |
| Comparative | Acidity is too strong. | X |
| Example 2 | | |

Potassium chloride, Tomita Pharmaceutical Co., Ltd.
Acetic acid powder (42.3% acetic acid and 57.7% sodium acetate), Nippon Synthetic Chemical Industry Co., Ltd
Lactic acid powder (60% lactic acid and 40% calcium lactate), Musashino Chemical Laboratory, Ltd.

Evaluation Indicators in Tables 18 and 19

©: A salty taste with a good balance is maintained as a whole (from initial taste to aftertaste).

o: A salty taste is sufficient as a whole (from initial taste to aftertaste).

Δ: A salty taste is insufficient but acceptable as a whole, although there is acceptable acidity.

x: A salty taste is insufficient, or acidity is excessive.

### Experiment 10: Stew Roux

Stew roux was prepared in accordance with the following procedure.

The raw materials shown in Tables 20 and 21 were mixed to prepare the first formulation and the second formulation, and the stock formulation shown in Table 22 was prepared using the same. The raw materials shown in Table 23 were measured and mixed to prepare a powder mixture. The raw materials shown in Table 24 were heated to 115° C. for 30 minutes to prepare wheat flour roux.

Stew roux was prepared in accordance with the final formulation shown in Table 25. Wheat flour roux and a mixture of beef fat and lard were introduced, and the resultant was heated to 80° C. The heated mixture was solidified via cooling to obtain roux, 300 g of hot water was added to 48 g of the resulting roux, the roux was dissolved via heating, and the resultants were heated to the boiling point, followed by evaluation. The results of evaluation are shown in Table 26.

TABLE 20
(First formulation)

| | | Comparative | | | | | | | Comparative |
|---|---|---|---|---|---|---|---|---|---|
| | Cont. | Example 1 | Example 1 | Example 2 | Example 3 | Example 4 | Example 5 | Example 6 | Example 2 |
| Yeast extract | 16 | 16 | 16 | 16 | 16 | 16 | 16 | 16 | 16 |
| Powdered skim milk | 170 | 170 | 170 | 170 | 170 | 170 | 170 | 170 | 170 |
| Dry buttermilk | 36 | 36 | 36 | 36 | 36 | 36 | 36 | 36 | 36 |
| Vegetable extract powder | 8 | 8 | 8 | 8 | 8 | 8 | 8 | 8 | 8 |
| Chicken extract powder | 0.8 | 0.8 | 0.8 | 0.8 | 0.8 | 0.8 | 0.8 | 0.8 | 0.8 |
| Sodium inosinate | 1 | 1 | 1 | 1 | 1 | 1 | 1 | 1 | 1 |
| Garlic powder | 0.8 | 0.8 | 0.8 | 0.8 | 0.8 | 0.8 | 0.8 | 0.8 | 0.8 |
| Citric acid | 0.9 | 0.9 | 0.9 | 0.9 | 0.9 | 0.9 | 0.9 | 0.9 | 0.9 |
| Sucrose fatty acid ester | 4 | 4 | 4 | 4 | 4 | 4 | 4 | 4 | 4 |
| Dextrin | 6 | 6 | 6 | 6 | 6 | 6 | 6 | 6 | 6 |
| Total | 243.5 | 243.5 | 243.5 | 243.5 | 243.5 | 243.5 | 243.5 | 243.5 | 243.5 |

TABLE 21
(Second formulation)

| | | Comparative | | | | | | | Comparative |
|---|---|---|---|---|---|---|---|---|---|
| | Cont. | Example 1 | Example 1 | Example 2 | Example 3 | Example 4 | Example 5 | Example 6 | Example 2 |
| Dextrin | 60.6 | 60.6 | 60.6 | 60.6 | 60.6 | 60.6 | 60.6 | 60.6 | 60.6 |
| Sodium glutamate | 35 | 35 | 35 | 35 | 35 | 35 | 35 | 35 | 35 |
| Total | 95.6 | 95.6 | 95.6 | 95.6 | 95.6 | 95.6 | 95.6 | 95.6 | 95.6 |

TABLE 22
(Stock formulation)

| | | Comparative | | | | | | | Comparative |
|---|---|---|---|---|---|---|---|---|---|
| | Cont. | Example 1 | Example 1 | Example 2 | Example 3 | Example 4 | Example 5 | Example 6 | Example 2 |
| First formulation | 155 | 155 | 155 | 155 | 155 | 155 | 155 | 155 | 155 |
| Second formulation | 95.6 | 95.6 | 95.6 | 95.6 | 95.6 | 95.6 | 95.6 | 95.6 | 95.6 |
| Total | 250.6 | 250.6 | 250.6 | 250.6 | 250.6 | 250.6 | 250.6 | 250.6 | 250.6 |

TABLE 23
(Mixed powder)

| | | Comparative | | | | | | | Comparative |
|---|---|---|---|---|---|---|---|---|---|
| | Cont. | Example 1 | Example 1 | Example 2 | Example 3 | Example 4 | Example 5 | Example 6 | Example 2 |
| Common salt | 90 | 54 | 54 | 54 | 54 | 54 | 45 | 45 | 45 |
| Dextrin | 28.3 | 64.3 | 17.76 | 15.2 | 13.7 | 12 | 6.4 | 3.2 | 0 |
| Potassium chloride | 0 | 0 | 45.9 | 45.9 | 45.9 | 45.9 | 57.3 | 57.3 | 57.3 |
| Acetic acid powder | 0 | 0 | 0.3 | 1.5 | 1.5 | 3 | 4.5 | 6 | 7.5 |
| Lactic acid powder | 0 | 0 | 0.34 | 1.7 | 1.7 | 3.4 | 5.1 | 6.8 | 8.5 |
| Corn starch | 200 | 200 | 200 | 200 | 200 | 200 | 200 | 200 | 200 |
| Granulated sugar | 115 | 115 | 115 | 115 | 115 | 115 | 115 | 115 | 115 |
| White pepper powder | 0 | 0 | 0 | 0 | 1.5 | 0 | 0 | 0 | 0 |
| Total | 433.3 | 433.3 | 433.3 | 433.3 | 433.3 | 433.3 | 433.3 | 433.3 | 433.3 |

TABLE 24
(Wheat flour roux formulation)

| | | Comparative | | | | | | | Comparative |
|---|---|---|---|---|---|---|---|---|---|
| | Cont. | Example 1 | Example 1 | Example 2 | Example 3 | Example 4 | Example 5 | Example 6 | Example 2 |
| Mixture of beef fat and lard | 220 | 220 | 220 | 220 | 220 | 220 | 220 | 220 | 220 |
| Wheat flour | 220 | 220 | 220 | 220 | 220 | 220 | 220 | 220 | 220 |
| Total | 440 | 440 | 440 | 440 | 440 | 440 | 440 | 440 | 440 |

TABLE 25
(Final formulation)

| | | Compar- | | | | | | | Compar- |
|---|---|---|---|---|---|---|---|---|---|
| | | ative | | | | | | | ative |
| | Cont. | Example 1 | Example 1 | Example 2 | Example 3 | Example 4 | Example 5 | Example 6 | Example 2 |
| Wheat flour roux formulation | 440 | 440 | 440 | 440 | 440 | 440 | 440 | 440 | 440 |
| Mixture of beef fat and lard | 270 | 270 | 270 | 270 | 270 | 270 | 270 | 270 | 270 |
| Stock formulation | 250.6 | 250.6 | 250.6 | 250.6 | 250.6 | 250.6 | 250.6 | 250.6 | 250.6 |
| Mixed powder | 433.3 | 433.3 | 433.3 | 433.3 | 433.3 | 433.3 | 433.3 | 433.3 | 433.3 |
| Total | 1393.9 | 1393.9 | 1393.9 | 1393.9 | 1393.9 | 1393.9 | 1393.9 | 1393.9 | 1393.9 |
| Evaluation | ⊚ | X | ◯ | ⊚ | ⊚ | ⊚ | ◯ | Δ | X |
| Acetic acid (mg/100 g) | 5 | 5 | 23.04 | 95.20 | 95.20 | 185.40 | 275.61 | 365.81 | 456.01 |
| Lactic acid (mg/100 g) | 17 | 17 | 37.28 | 118.39 | 118.39 | 219.78 | 321.17 | 422.55 | 523.94 |
| Na (g/100 g) | 3.06 | 2.04 | 2.05 | 2.06 | 2.06 | 2.08 | 1.85 | 1.87 | 1.89 |
| Sodium chloride equivalent | 7.78 | 5.20 | 5.21 | 5.24 | 5.24 | 5.29 | 4.71 | 4.76 | 4.80 |
| (g/100 g) | | | | | | | | | |
| Amount of acetic acid and | 0.003 | 0.004 | 0.012 | 0.041 | 0.041 | 0.077 | 0.127 | 0.166 | 0.204 |
| lactic acid/sodium chloride | | | | | | | | | |

TABLE 26 [symbol]
Evaluation

[symbol]

| | | |
|---|---|---|
| Cont. | Mildly-tasted cream stew with a milk taste. | ⊚ |
| Comparative | A salty taste is lost, flavor is | X |
| Example 1 | weakened as a whole, but sweetness | |
| | stands out with a sense of something | |
| | missing. | |
| Example 1 | A salty taste is complemented (from | ◯ |
| | initial taste to aftertaste). | |
| Example 2 | A salty taste with a good balance is | ⊚ |
| | maintained as a whole (from initial | |
| | taste to aftertaste) | |
| Example 3 | Rise of the initial taste becomes | ⊚ |
| | strong, and taste coherence is further | |
| | improved, in addition to properties of | |
| | Example 2. | |
| Example 4 | A salty taste with a good balance is | ⊚ |
| | maintained as a whole (from initial | |
| | taste to aftertaste) | |
| Example 5 | A salty taste is sufficient as a | ◯ |
| | whole, although there is mild acidity. | |
| Example 6 | A salty taste is sufficient as a whole, | Δ |
| | although there is acceptable acidity. | |
| Comparative | Acidity is too strong. | X |
| Example 2 | | |

Potassium chloride, Tomita Pharmaceutical Co., Ltd.
Acetic acid powder(42.3% acetic acid and 57.7% sodium acetate), Nippon Synthetic Chemical Industry Co., Ltd
Lactic acid powder (60% lactic acid and 40% calcium lactate), Musashino Chemical Laboratory, Ltd.

Evaluation Indicators in Tables 25 and 26

©: A salty taste with a good balance is maintained as a whole (from initial taste to aftertaste).

o: A salty taste is sufficient as a whole (from initial taste to aftertaste).

Δ: A salty taste is insufficient but acceptable as a whole, although there is acceptable acidity.

x: A salty taste is insufficient, or acidity is excessive.

### Experiment 11: Soup Powder

All raw materials shown in Table 27 were mixed to prepare soup powder.

The obtained soup powder (10 g) was introduced into 350 ml of boiled water to prepare soup, followed by evaluation. The results of evaluation are shown in Table 28.

TABLE 27 [symbol]
Formulation

[symbol]

| | | Comparative | | | | | | | Comparative |
|---|---|---|---|---|---|---|---|---|---|
| | Cont | Example 1 | Example 1 | Example 2 | Example 3 | Example 4 | Example 5 | Example 6 | Example 2 |
| Common salt | 20 | 12 | 12 | 12 | 12 | 12 | 8 | 8 | 8 |
| Sodium glutamate | 7 | 7 | 7 | 7 | 7 | 7 | 7 | 7 | 7 |
| Granulated sugar | 2 | 2 | 2 | 2 | 2 | 2 | 2 | 2 | 2 |
| Chicken extract powder | 3 | 3 | 3 | 3 | 3 | 3 | 3 | 3 | 3 |
| Pork extract powder | 1.2 | 1.2 | 1.2 | 1.2 | 1.2 | 1.2 | 1.2 | 1.2 | 1.2 |
| Bonito broth powder | 1.3 | 1.3 | 1.3 | 1.3 | 1.3 | 1.3 | 1.3 | 1.3 | 1.3 |
| Garlic powder | 1.2 | 1.2 | 1.2 | 1.2 | 1.2 | 1.2 | 1.2 | 1.2 | 1.2 |
| Soy sauce powder | 15 | 15 | 15 | 15 | 15 | 15 | 15 | 15 | 15 |
| Caramel powder | 2 | 2 | 2 | 2 | 2 | 2 | 2 | 2 | 2 |
| Potassium chloride | 0 | 0 | 10.2 | 10.2 | 10.2 | 10.2 | 15.3 | 15.3 | 15.3 |
| Acetic acid powder | 0 | 0 | 0.05 | 0.3 | 0.3 | 0.72 | 0.9 | 1.2 | 1.65 |
| Lactic acid powder | 0 | 0 | 0.067 | 0.4 | 0.4 | 0.96 | 1.2 | 1.6 | 2.2 |
| White pepper powder | 0 | 0 | 0 | 0 | 0.06 | 0 | 0 | 0 | 0 |
| Dextrin | 9.8 | 17.8 | 7.5 | 6.9 | 6.8 | 5.9 | 4.4 | 3.7 | 2.6 |
| Total | 62.5 | 62.5 | 62.5 | 62.5 | 62.5 | 62.5 | 62.5 | 62.5 | 62.5 |
| Evaluation | ⊚ | X | ◯ | ⊚ | ⊚ | ⊚ | ◯ | Δ | X |
| Acetic acid (mg/100 g) | 42.0 | 42.0 | 109.1 | 444.3 | 444.3 | 1007.9 | 1249.0 | 1651.4 | 2256.7 |
| Lactic acid (mg/100 g) | 630 | 630 | 719.1 | 1162.0 | 1152.0 | 1907.3 | 2226.1 | 2758.2 | 3558.6 |
| Na (g/100 g) | 19.5 | 14.5 | 14.5 | 14.5 | 14.5 | 14.6 | 12.2 | 12.3 | 12.4 |
| Sodium chloride equivalent | 49.6 | 36.8 | 36.8 | 37.0 | 37.0 | 37.3 | 31.1 | 31.3 | 31.6 |
| (g/100 g) | | | | | | | | | |
| Amount of acetic acid and | 0.014 | 0.018 | 0.022 | 0.043 | 0.043 | 0.078 | 0.112 | 0.141 | 0.184 |
| lactic acid/sodium chloride | | | | | | | | | |

TABLE 28 [symbol]
Evaluation results

[symbol]

| | | |
|---|---|---|
| Cont | Soy sauce well-flavored with bonito | ⊚ |
| | broth and chicken broth | |
| Comparative | A salty taste is lost, and flavor is | X |
| Example 1 | weakened as a whole with a sense of | |
| | something missing | |
| Example 1 | A salty taste is complemented (from | ◯ |
| | initial taste to aftertaste). | |
| Example 2 | A salty taste with a good balance is | ⊚ |
| | maintained as a whole (from initial | |
| | taste to aftertaste). | |
| Example 3 | Rise of the initial taste becomes | ⊚ |
| | strong, and taste coherence is | |
| | further improved, in addition to | |
| | properties of Example 2. | |
| Example 4 | A salty taste with a good balance | ⊚ |
| | is maintained as a whole (from | |
| | initial taste to aftertaste). | |
| Example 5 | A salty taste is sufficient as a whole, | ◯ |
| | although there is mild acidity. | |
| Example 6 | A salty taste is sufficient as a whole, | Δ |
| | although there is acceptable acidity. | |
| Comparative | Acidity is too strong. | X |
| Example 2 | | |

Potassium chloride, Tomita Pharmaceutical Co., Ltd.
Acetic acid powder(42.3% acetic acid and 57.7% sodium acetate), Nippon Synthetic Chemical Industry Co., Ltd
Lactic acid powder (60% lactic acid and 40% calcium lactate), Musashino Chemical Laboratory, Ltd.

Evaluation Indicators in Tables 27 and 28

©: A salty taste with a good balance is maintained as a whole (from initial taste to aftertaste).

o: A salty taste is sufficient as a whole (from initial taste to aftertaste).

Δ: A salty taste is insufficient but acceptable as a whole, although there is acceptable acidity.

x: A salty taste is insufficient, or acidity is excessive.

Experiment 12: Snacks (French Fries)

Oil was heated to about 180° C., and frozen potato shoestrings were introduced thereinto. Potatoes were heated until golden brown for about 3 minutes, and french fries of the formulation shown in Table 29 were prepared.

Raw materials shown in Table 30 were mixed in a bag, and dispersed in it to prepare furikake (seasoning powder).

The french fries and the furikake were introduced into a bag in accordance with the formulation shown in Table 31 and mixed with shaking to prepare seasoned french fries, followed by evaluation. The results of evaluation are shown in Table 32.

TABLE 29
(French fries)

| | |
|---|---|
| Potato shoestring | 1200 |
| Oil | Adequate amount |

TABLE 30
(Furikake)

| | Cont. & Comparative | | | | | | | Comparative |
|---|---|---|---|---|---|---|---|---|
| | Example 1 | Example 1 | Example 2 | Example 3 | Example 4 | Example 5 | Example 6 | Example 2 |
| Common salt | 50 | 30 | 30 | 30 | 30 | 25 | 25 | 25 |
| Potassium chloride | 0 | 25.5 | 25.5 | 25.5 | 25.5 | 31.9 | 31.9 | 31.9 |
| Acetic acid powder | 0 | 0.30 | 0.87 | 0.87 | 1.74 | 2.18 | 2.61 | 3.05 |
| Lactic acid powder | 0 | 0.40 | 1.15 | 1.15 | 2.30 | 2.88 | 3.45 | 4.03 |
| White pepper powder | 0 | 0.00 | 0.00 | 0.05 | 0.00 | 0.00 | 0.00 | 0.00 |
| Total | 50 | 56.19 | 57.51 | 57.56 | 59.54 | 61.96 | 62.96 | 63.98 |

TABLE 31

| | | Comparative | | | | | | | Comparative |
|---|---|---|---|---|---|---|---|---|---|
| | Cont. | Example 1 | Example 1 | Example 2 | Example 3 | Example 4 | Example 5 | Example 6 | Example 2 |
| French fries | 150 | 150 | 150 | 150 | 150 | 150 | 150 | 150 | 150 |
| Furikake | 1.30 | 0.78 | 1.46 | 1.50 | 1.50 | 1.55 | 1.61 | 1.64 | 1.67 |
| Evaluation | ⊚ | X | ◯ | ⊚ | ⊚ | ⊚ | ◯ | Δ | X |
| Acetic acid (mg/100 g) | 1 | 1 | 5.43 | 13.61 | 13.61 | 25.25 | 30.11 | 35.39 | 40.55 |
| Lactic acid (mg/100 g) | 7.7 | 7.7 | 13.56 | 24.16 | 24.16 | 39.49 | 45.93 | 52.79 | 59.53 |
| Na (g/100 g) | 0.349 | 0.215 | 0.215 | 0.217 | 0.217 | 0.219 | 0.185 | 0.187 | 0.189 |
| Sodium chloride equivalent | 0.89 | 0.55 | 0.55 | 0.55 | 0.55 | 0.56 | 0.47 | 0.48 | 0.48 |
| (g/100 g) | | | | | | | | | |
| Amount of acetic acid and | 0.01 | 0.02 | 0.03 | 0.07 | 0.07 | 0.12 | 0.16 | 0.19 | 0.21 |
| lactic acid/sodium chloride | | | | | | | | | |

TABLE 32 [symbol]
Evaluation

[symbol]

| | | |
|---|---|---|
| Cont. | Potato flavor with roasted salty taste | ⊚ |
| Comparative | Insufficient potato flavor due to a | X |
| Example 1 | lack of salty taste | |
| Example 1 | A salty taste is complemented (from | ◯ |
| | initial taste to aftertaste). | |
| Example 2 | A salty taste with a good balance is | ⊚ |
| | maintained as a whole with a sufficient | |
| | potato flavor. | |
| Example 3 | Rise of the initial salty taste becomes | ⊚ |
| | strong, and taste coherence is further | |
| | improved, in addition to properties of | |
| | Example 2. | |
| Example 4 | A salty taste with a good balance is | ⊚ |
| | maintained as a whole, and a potato | |
| | flavor is sufficiently sensed. | |
| Example 5 | A salty taste is sufficient as a whole, | ◯ |
| | although there is mild acidity. | |
| Example 6 | A salty taste is sufficient as a whole, | Δ |
| | although there is acceptable acidity. | |
| Comparative | Acidity is too strong. | X |
| Example 2 | | |

Potassium chloride, Tomita Pharmaceutical Co., Ltd.
Acetic acid powder (42.3% acetic acid and 57.7% sodium acetate), Nippon Synthetic Chemical Industry Co., Ltd
Lactic acid powder (60% lactic acid and 40% calcium lactate), Musashino Chemical Laboratory, Ltd.

Evaluation Indicators in Tables 31 and 32

©: A salty taste with a good balance is maintained as a whole (from initial taste to aftertaste).

o: A salty taste is sufficient as a whole (from initial taste to aftertaste).

Δ: A salty taste is insufficient but acceptable as a whole, although there is acceptable acidity.

x: A salty taste is insufficient, or acidity is excessive.

### Experiment 13: Seasoned Salt

All raw materials shown in Table 33 were mixed to prepare seasoned salt, followed by evaluation. The results of evaluation are shown in Table 34.

TABLE 33
(Seasoned salt)

| | | | | | | | | Comparative |
|---|---|---|---|---|---|---|---|---|
| | Cont. | Example 1 | Example 2 | Example 3 | Example 4 | Example 5 | Example 6 | Example 2 |
| Common salt | 50 | 30 | 30 | 30 | 30 | 25 | 25 | 25 |
| Potassium chloride | 0 | 25.5 | 25.5 | 25.5 | 25.5 | 31.9 | 31.9 | 31.9 |
| Acetic acid powder | 0 | 0.06 | 0.60 | 0.60 | 1.20 | 1.50 | 1.80 | 2.40 |
| Lactic acid powder | 0 | 0.08 | 0.80 | 0.80 | 1.60 | 2.00 | 2.40 | 3.20 |
| White pepper powder | 0 | 0.00 | 0.00 | 0.05 | 0.00 | 0.00 | 0.00 | 0.00 |
| Total | 50 | 55.6 | 56.9 | 56.9 | 58.3 | 60.4 | 61.1 | 62.5 |
| Evaluation | ⊚ | ◯ | ⊚ | ⊚ | ⊚ | ◯ | Δ | X |
| Acetic acid (mg/100 g) | 0 | 90.41 | 884.08 | 884.08 | 1725.70 | 2081.67 | 2469.38 | 3218.76 |
| Lactic acid (mg/100 g) | 0 | 119.56 | 1169.09 | 1169.09 | 2282.02 | 2752.74 | 3265.44 | 4256.40 |
| Na (g/100 g) | 39.32 | 21.22 | 20.90 | 20.89 | 20.57 | 16.68 | 16.56 | 16.35 |
| Sodium chloride equivalent | 100 | 53.97 | 53.17 | 53.12 | 52.32 | 42.41 | 42.13 | 41.58 |
| (g/100 g) | | | | | | | | |
| Amount of acetic acid and | 0 | 0.004 | 0.039 | 0.039 | 0.077 | 0.114 | 0.136 | 0.180 |
| lactic acid/sodium chloride | | | | | | | | |

TABLE 34 [symbol]
Evaluation

[symbol]

| | | |
|---|---|---|
| Cont. | — | ⊚ |
| Example 1 | A salty taste is complemented (from initial | ◯ |
| | taste to aftertaste). | |
| Example 2 | A salty taste with a good balance is | ⊚ |
| | maintained as a whole (from initial taste | |
| | to aftertaste). | |
| Example 3 | Rise of the initial salty taste becomes | ⊚ |
| | strong, and taste coherence is further | |
| | improved, in addition to properties of | |
| | Example 2. | |
| Example 4 | A salty taste with a good balance is | ⊚ |
| | maintained as a whole (from initial | |
| | taste to aftertaste). | |
| Example 5 | A salty taste is sufficient as a whole, | ◯ |
| | although there is mild acidity. | |
| Example 6 | A salty taste is sufficient as a whole, | Δ |
| | although there is acceptable acidity. | |
| Comparative | Acidity is too strong. | X |
| Example 2 | | |

Potassium chloride, Tomita Pharmaceutical Co., Ltd.
Acetic acid powder(42.3% acetic acid and 57.7% sodium acetate), Nippon Synthetic Chemical Industry Co., Ltd
Lactic acid powder (60% lactic acid and 40% calcium lactate), Musashino Chemical Laboratory, Ltd.

Evaluation Indicators in Tables 33 and 34

©: A salty taste with a good balance is maintained as a whole (from initial taste to aftertaste).

o: A salty taste is sufficient as a whole (from initial taste to aftertaste).

Δ: A salty taste is insufficient but acceptable as a whole, although there is acceptable acidity.

x: A salty taste is insufficient, or acidity is excessive.

### Experiment 14: Liquid Seasoning (Japanese-Style Dressing)

All raw materials shown in Table 35 were mixed, the mixture was heated to 80° C., and the resultant was cooled to prepare Japanese-style dressing. The resulting Japanese-style dressing was evaluated. The results of evaluation are shown in Table 36.

TABLE 35 [symbol]
Formulation

[symbol]

| | | Comparative | | | | | | | |
|---|---|---|---|---|---|---|---|---|---|
| | Cont. | Example 1 | Example 1 | Example 2 | Example 3 | Example 4 | Example 5 | Example 6 | Example 7 |
| Hon Katsuo dashi (bonito stock) granules | 1 | 1 | 1 | 1 | 1 | 1 | 1 | 1 | 1 |
| High-fructose corn syrup | 12 | 12 | 12 | 12 | 12 | 12 | 12 | 12 | 12 |
| Superfine sugar | 9.4 | 9.4 | 9.4 | 9.4 | 9.4 | 9.4 | 9.4 | 9.4 | 9.4 |
| Marudaizu Shoyu (soy sauce made from | 56 | 56 | 56 | 56 | 56 | 56 | 56 | 56 | 56 |
| whole soy beans) | | | | | | | | | |
| High-acid acetic acid | 28 | 28 | 28 | 28 | 28 | 28 | 28 | 28 | 28 |
| Common salt | 7.2 | 4.32 | 4.32 | 4.32 | 4.32 | 0.74 | 0.74 | 0 | 0 |
| Potassium chloride | 0 | 0 | 3.67 | 3.67 | 3.67 | 8.2 | 8.2 | 9.2 | 9.2 |
| Acetic acid powder | 0 | 0 | 0.062 | 0.124 | 0.124 | 0.28 | 0.56 | 0.84 | 1.5 |
| Fermentation lactic acid | 0 | 0 | 0.081 | 0.162 | 0.162 | 0.366 | 0.732 | 1.1 | 2 |
| White pepper powder | 0 | 0 | 0 | 0 | 0.06 | 0 | 0 | 0 | 0 |
| Water | 116.8 | 119.7 | 115.9 | 115.7 | 115.7 | 114.4 | 113.8 | 112.9 | 111.3 |
| Total | 230.4 | 230.4 | 230.4 | 230.4 | 230.4 | 230.4 | 230.4 | 230.4 | 230.4 |
| Evaluation | ⊚ | X | ◯ | ⊚ | ⊚ | ⊚ | ◯ | ◯ | Δ |
| Acetic acid (mg/100 g) | 1000 | 1000 | 1023 | 1045 | 1045 | 1102 | 1204 | 1306 | 1546 |
| Lactic acid (mg/100 g) | 170 | 170 | 187.6 | 205.2 | 205.3 | 249.4 | 328.9 | 408.7 | 604.0 |
| Na (g/100 g) | 2.54 | 2.05 | 2.05 | 2.06 | 2.06 | 1.46 | 1.48 | 1.37 | 1.42 |
| Sodium chloride equivalent (g/100 g) | 6.46 | 5.21 | 5.22 | 5.23 | 5.23 | 3.71 | 3.76 | 3.49 | 3.60 |
| Amount of acetic acid and lactic | 0.18 | 0.22 | 0.23 | 0.24 | 0.24 | 0.36 | 0.41 | 0.49 | 0.60 |
| acid/sodium chloride | | | | | | | | | |

TABLE 36 [symbol]
Evaluation

[symbol]

| | | |
|---|---|---|
| Cont. | Japanese-style dressing with bonito | ⊚ |
| | flavor | |
| Comparative | A salty taste is lost, and a sweet | X |
| Example 1 | taste stands out with a sense of | |
| | something missing. | |
| Example 1 | A salty taste is complemented (from | ◯ |
| | initial taste to aftertaste). | |
| Example 2 | A salty taste with a good balance is | ⊚ |
| | maintained as a whole (from initial | |
| | taste to aftertaste). | |
| Example 3 | Rise of the initial salty taste becomes | ⊚ |
| | strong, and taste coherence is further | |
| | improved, in addition to properties | |
| | of Example 2. | |
| Example 4 | A salty taste with a good balance is | ⊚ |
| | maintained as a whole (from initial | |
| | taste to aftertaste). | |
| Example 5 | A salty taste is sufficient as a whole, | ◯ |
| | although there is mild acidity. | |
| Example 6 | A salty taste is sufficient as a whole, | ◯ |
| | although there is mild acidity. | |
| Example 7 | A salty taste is sufficient as a whole, | Δ |
| | although there is acceptable acidity. | |

Potassium chloride, Tomita Pharmaceutical Co., Ltd.
Acetic acid powder(42.3% acetic acid and 57.7% sodium acetate), Nippon Synthetic Chemical Industry Co., Ltd
High-acid acetic acid (Acetic acid 1O%), Marukan Vinegar Co., Ltd.
Lactic acid powder (60% lactic acid and 40% calcium lactate), Musashino Chemical Laboratory, Ltd.

Evaluation Indicators in Tables 35 and 36

©: A salty taste with a good balance is maintained as a whole (from initial taste to aftertaste).

o: A salty taste is sufficient as a whole (from initial taste to aftertaste).

Δ: A salty taste is insufficient but acceptable as a whole, although there is acceptable acidity.

x: A salty taste is insufficient, or acidity is excessive.

All publications, patents, and patent applications cited herein are incorporated herein by reference in their entirety.

1. A method for reinforcing a salty taste of a food composition with reduced sodium chloride content comprising a step of
adding potassium chloride and at least one acid selected from acetic acid and lactic acid to the composition,
provided that a method of reinforcing a salty taste of a seasoning composition with reduced sodium chloride content comprising a step of adding potassium chloride, lactic acid, calcium salt, magnesium salt, and rice powder to the composition is excluded.

2. The method of claim 1, which further comprises a step of
adjusting the amount of potassium chloride and the amount of the acid added to the food composition in accordance with the amount of sodium chloride reduced.

3. The method of claim 1, which further comprises a step of
adding at least one spice selected from among white pepper, black pepper, green pepper, ginger, zanthoxylum, capsicum, cumin, thyme, oregano, coriander, laurel, cardamom, mustard, cinnamon, garlic, rosemary, sage, basil, citrus unshiu peel, perilla, and lemon and an extract of any thereof.

4. A food composition with reduced sodium chloride content comprising potassium chloride and at least one acid selected from acetic acid and lactic acid, provided that a seasoning composition with reduced sodium chloride content comprising potassium chloride, lactic acid, calcium salt, magnesium salt, and rice powder is excluded.

5. The food composition of claim 4, wherein the composition is sauce, soup, baste, soy sauce, bean paste, dressing, edible salt, seasoning, a snack, noodles, or seasoned rice.

6. The food composition of claim 4, wherein the composition is curry sauce, wherein the amount of sodium in terms of an amount converted to equimolar sodium chloride or the sodium chloride equivalent is 1.25% by weight or less, and wherein the total amount of the acids is 2.6 to 52.0 parts by weight based on 100 parts by weight of the sodium chloride equivalent.

7. The food composition of claim 4, wherein the composition is curry roux used for preparing curry sauce, wherein the sodium chloride equivalent in the curry sauce is 1.25% by weight or less, and wherein the amount of the acids in the curry roux is adjusted so as to bring the total amount of the acids in the curry sauce to 2.6 to 52.0 parts by weight based on 100 parts by weight of the sodium chloride equivalent.

8. The food composition of claim 4, wherein the composition is curry roux used for preparing curry sauce, wherein the sodium chloride equivalent in the curry roux is 11.5% by weight or less, and wherein the total amount of the acids in the curry roux is 0.8 to 17.0 parts by weight based on 100 parts by weight of the sodium chloride equivalent.

9. The food composition of claim 4, wherein the composition is stew sauce, wherein the sodium chloride equivalent is 1.0% by weight or less and the total amount of the acids is 5.3 to 30.0 parts by weight based on 100 parts by weight of the sodium chloride equivalent.

10. The food composition of claim 4, wherein the composition is stew roux used for preparing stew sauce, wherein the sodium chloride equivalent in the stew sauce is 1.0% by weight or less of the stew sauce, and wherein the amount of the acids in the stew roux is adjusted so as to bring the total amount of the acids in the stew sauce to 5.3 to 30.0 parts by weight based on 100 parts by weight of the sodium chloride equivalent.

11. The food composition of claim 4, wherein the composition is stew roux used for preparing stew sauce, wherein the sodium chloride equivalent in the stew roux is 8.5% by weight or less, and wherein the total amount of the acids in the stew roux is 0.7 to 17.0 parts by weight based on 100 parts by weight of the sodium chloride equivalent.

12. The food composition of claim 4, wherein the composition is soup, in which the sodium chloride equivalent is 1.3% by weight or less and the total amount of the acids is 2.0 to 16.0 parts by weight based on 100 parts by weight of the sodium chloride equivalent.

13. The food composition of claim 4, wherein the composition is a soup base used for preparing soup, wherein the sodium chloride equivalent in the soup is 1.3% by weight or less, and wherein the amount of the acids in the soup base is adjusted so as to bring the total amount of the acids in the soup to 2.0 to 16.0 parts of by weight based on 100 parts by weight of the sodium chloride equivalent.

14. The food composition of claim 4, wherein the composition is a snack, wherein the sodium chloride equivalent is 1.4% by weight or less and the total amount of the acids is 2.5 to 20.0 parts by weight based on 100 parts by weight of the sodium chloride equivalent.

15. The food composition of claim 4, wherein the composition is an edible salt comprising 25% to 98% by weight of potassium chloride.

16. The food composition of claim 15, wherein the total amount of the acids contained in the edible salt is 0.2 to 15.0 parts by weight based on 100 parts by weight of the sodium chloride equivalent.

17. The food composition of claim 4, wherein the composition is a dressing, in which the sodium chloride equivalent is 5.5% by weight or less and the total amount of the acids is 22.5 to 90.0 parts by weight based on 100 parts by weight of the sodium chloride equivalent.

18. A method of enhancing the salty taste of a food composition containing sodium chloride, which comprises a step of
adding potassium chloride and at least one acid selected from acetic acid and lactic acid to the composition.

19. A food composition comprising sodium chloride, potassium chloride and at least one acid selected from acetic acid and lactic acid.

20. A composition comprising potassium chloride, and at least one acid selected from glutamic acid and aspartic acid wherein the offensive taste originating from the potassium is suppressed.

21. A composition comprising potassium chloride and 2 to 25 parts by weight of at least one acid selected from glutamic acid and aspartic acid based on 100 parts by weight of potassium chloride.

22. The composition of claim 20, wherein the composition is sauce, soup, baste, soy sauce, bean paste, edible salt, seasoning, a snack, noodles, or seasoned rice.

23. The composition of claim 20, wherein the composition is curry sauce, in which the total of the amount of sodium chloride contained in the curry sauce and the amount of potassium chloride added in terms of an amount converted to equimolar sodium chloride or the total amount of salt is 1.1% or less.

24. The composition of claim 20, wherein the composition is stew sauce, in which the total amount of salts is 0.75% by weight or less.

25. The composition of claim 20, wherein the composition is soup, in which the total amount of salts is 1.0% by weight or less.

26. The composition of claim 20, wherein the composition is a snack, in which the total amount of salts is 1.3% by weight or less.

27. The composition of claim 20, wherein the composition is an edible salt comprising 30% to 98% by weight of potassium chloride.

28. A method for suppressing the offensive taste of a composition supplemented with potassium chloride comprising
adding at least one acid selected from glutamic acid and aspartic acid to the composition, wherein the offensive taste originating from the potassium is suppressed.

29. The composition of claim 21, wherein the composition is sauce, soup, baste, soy sauce, bean paste, edible salt, seasoning, a snack, noodles, or seasoned rice.

30. The composition of claim 21, wherein the composition is curry sauce, in which the total of the amount of sodium chloride contained in the curry sauce and the amount of potassium chloride added in terms of an amount converted to equimolar sodium chloride or the total amount of salts is 1.1% or less.

31. The composition of claim 21, wherein the composition is stew sauce, in which the total amount of salts is 0.75% by weight or less.

32. The composition of claim 21, wherein the composition is soup, in which the total amount of salts is 1.0% by weight or less.

33. The composition of claim 21, wherein the composition is a snack, in which the total amount of salts is 1.3% by weight or less.

34. The composition of claim 21, wherein the composition is an edible salt comprising 30% to 98% by weight of potassium chloride.
